(19) United States
(12) Patent Application Publication
(10) Pub. No.: US 2005/0003878 A1
(43) Pub. Date: Jan. 6, 2005

(54) Methods and apparatus for fairly placing players in bet positions

(76) Inventor: Kim Updike, Madison, WI (US)

Correspondence Address: James F Goedken;Wallenstein & Wagner, 53rd Floor, 311 South Wacker Drive, Chicago, IL, 60606-6630, US

(21) Appl. No.: 10/491,840

(22) PCT Filed: Jul. 31, 2002
(86) PCT No.: PCT/US02/24332

Related U.S. Application Data
(60) Provisional application No. 60/309,321, filed on Aug. 1, 2001.

(51) Int. Cl. A63F 13/00

(52) U.S. Cl. 463/16

(57) ABSTRACT

The apparatus and methods described herein facilitate fair peer-to-peer gambling. Generally, the system receives bet statement(s) from authorized player(s) and/or game administrator(s). Authorized players(s) then enter whole number percentages representing their beliefs that the outcome of the bet statement will be true. The players entering the risk percentages are encouraged to be as fair as possible, because players may be forced into undesirable bet positions. The amount of points or money wagered are then automatically determined based on the risk percentage(s). Once the actual outcome is determined, the winning player is rewarded in inverse proportion to his risk percentage.

### RELATED APPLICATIONS

This application is a continuation-in-part of U.S. Ser. No. 09/840,574 filed Apr. 23, 2001 and claims priority to U.S. Provisional Ser. No. 60/309,321, filed Aug. 1, 2001.

### TECHNICAL FIELD

This disclosure relates to gambling systems, and, in particular, to methods and apparatus of fairly placing players in bet positions.

### BACKGROUND

When a gambling operation sets odds for a bet it is offering it normally attempts to do it in a way that is favorable to the gambling operation so that it can make a profit. Wagering directly with a friend avoids the unfair odds and bets of profit-seeking gambling operations.

Setting odds is a challenging part of make-believe or real wagering that is normally done by a gambling operation rather than by individual gamblers. Entering a mutually attractive wager can be difficult because players have to communicate and agree on a variety of potential issues and decisions. If players adopt an automated system the process of wagering can be streamlined and dynamic in conceptual, technical and social respects. The odds that a gambling operation set have to be somewhat close to fair, meaning that the reward must be reflective and proportional to the risk. If the odds are not close to fair then people will not be enticed to make the bet.

Many gambling operations are lucrative because many people do not have a sophisticated understanding of odds and mathematical probability, or they don't understand the subject matter that is being wagered on well enough to accurately assess the risk associated with a bet and what fair odds would be.

The main reason that legal gambling operations in the U.S. can annually generate $60 billion after-pay-out gross profits (the skim) is that they set and offer unfair odds and many unsophisticated gamblers accept unfair, foolish bets. Addicted experienced gamblers will even knowingly take bad bets if those are the only bets that are available to feed their addiction. Most gamblers know that the odds are almost always designed to favor the house, but some people do not understand that or they underestimate the extent to which it is true.

The process of making a make-believe or real wager between two players can involve many different stages such as:
Finding and communicating with a suitable, interested wagering opponent.
Choosing and agreeing upon a bet statement.
Defining underlying assumptions and the criteria.
Choosing and agreeing on how much to bet.
Choosing and agreeing to which side of a bet each player is on.
Choosing and agreeing to odds.
Choosing and agreeing to an in increase in the bet amount.
Observing and proving the outcome of a bet statement.
Exchanging real or make-believe money or points.

This list of different stages excludes some potential work or stages that might occur. Here are two examples:
Documenting each decision in writing or by entering them into a computer.
Agreeing to odds or calculating winnings often can include calculations.

Just one stage, such as choosing and agreeing upon abet statement, can become complicated because certain bet statements could give one player an advantage because of their special knowledge or abilities. Therefore, you might need a process whereby players can veto bet statements. Also, if bet statements are not worded wisely they become too large or unclear.

### BRIEF DESCRIPTION OF THE DRAWINGS

Features and advantages of the disclosed system will be apparent to those of ordinary skill in the art in view of the detailed description of exemplary embodiments which is made with reference to the drawings, a brief description of which is provided below.

FIG. 1 is a high level block diagram of a network communications system.

FIG. 2 is a more detailed block diagram of one of the client devices illustrated in FIG. 1.

FIG. 3 is a more detailed block diagram showing one embodiment of the game server illustrated in FIG. 1.

FIG. 4 is a more detailed block diagram showing another embodiment of the game server illustrated in FIG. 1.

FIG. 5 is a flowchart of a process for facilitating fair peer-to-peer gambling.

FIG. 6 is a flowchart of a process for determining a player's bet position.

### DETAILED DESCRIPTION OF EXEMPLARY EMBODIMENTS

Introduction

In general, the apparatus and methods described herein facilitate fair peer-to-peer gambling. Generally, the system receives bet statement(s) from authorized player(s) and/or game administrator(s). Authorized player(s) then enter whole number percentages representing their beliefs that the outcome of the bet statement will be true. The players entering the risk percentages are encouraged to be as fair as possible, because the other players choose which side of the bet they will take and/or players are forced into certain bet positions. The amount of points or money wagered are then automatically determined based on the risk percentage. In addition, a predetermined scaling scheme which limits potential gambling losses to levels deemed acceptable by the players may be used. Once the actual outcome is determined, the winning player is rewarded in inverse proportion to his risk percentage. A winning player who is favored to win receives less than a winning player who is not favored to win. The winning points may be subtracted from the loser's account and added to the winner's account without a “house cut.” Of course, a person of ordinary skill in the art will readily appreciate that one of the players may be a casino, another gaming establishment, and/or a computing device. However, in such an instance, the “house” only receives funds if the house wins the bet and/or subscription fees are charged.

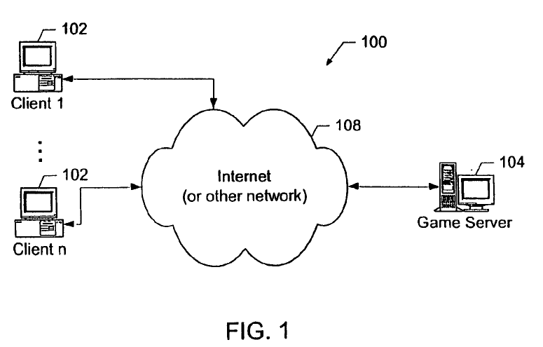

A high level block diagram of an exemplary network communications system 100 capable of employing the teachings of the present invention is illustrated in FIG. 1. Typically, the system 100 includes one or more client devices 102 and one or more game servers 104. Each of these devices may communicate with each other via a connection to the Internet or some other wide area network 108. Of course, a person of ordinary skill in the art will readily appreciate that local area networks and/or direct wired or wireless connections may also be used. For example, two bar patrons may bet against each other using one or more hand-held devices such as a PDA or cellular telephone. In such an instance, the hand-held device preferably displays a player's risk percentage only to that player (i.e., the entered risk percentage is hidden before other players enter their risk percentage).

Typically, game servers 104 store a plurality of files, programs, and/or web pages for use by the client devices 102. One game server 104 may handle requests from a large number of clients 102. Accordingly, each server 104 is typically a high end computer with a large storage capacity, one or more fast microprocessors, and one or more high speed network connections. Conversely, relative to a typical server 104, each client device 102 typically includes less storage capacity, a single microprocessor, and a single network connection.

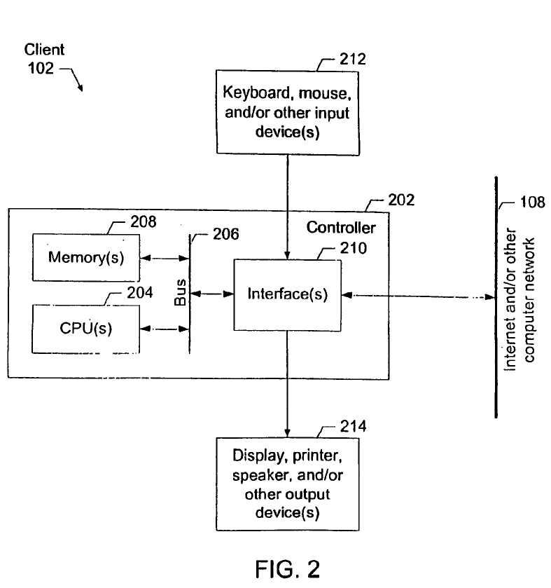

A more detailed block diagram of a client device 102 is illustrated in FIG. 2. The client device may be a personal computer (PC), a personal digital assistant (PDA), a cellular telephone, an Internet appliance, a dedicated stand-alone gambling device, and/or any other electronic device. The client 102 includes a controller 202 which preferably includes a central processing unit 204 electrically coupled by an address/data bus 206 to a memory device 208 and an interface circuit 210. The CPU 204 may be any type of well known CPU, such as an Intel Pentium™ processor. The memory device 208 preferably includes volatile memory and non-volatile memory. Preferably, the memory device 208 stores a software program that interacts with the game server 104 as described below. This program may be executed by the CPU 204 in a well known manner. The memory device 208 may also store digital data indicative of documents, files, programs, web pages, etc. retrieved from a game server 104 and/or loaded via an input device 212.

The interface circuit 210 may be implemented using any type of well known interface standard, such as an Ethernet interface and/or a Universal Serial Bus (USB) interface. One or more input devices 212 may be connected to the interface circuit 210 for entering data and commands into the controller 202. For example, the input device 212 may be a keyboard, mouse, touch screen, track pad, track ball, isopoint, and/or a voice recognition system.

One or more displays, printers, and/or other output devices 214 may also be connected to the controller 202 via the interface circuit 210. The display 214 may be cathode ray tube (CRTs), liquid crystal displays (LCDs), or any other type of display. The display 214 generates visual displays of data generated during operation of the client 102. The display 214 is typically used to display web pages received from the game server 104. The visual displays may include prompts for human operator input, run time statistics, calculated values, detected data, etc.

The client 102 may also exchange data with other devices via a connection to the network 108. The network connection may be any type of network connection, such as an Ethernet connection, digital subscriber line (DSL), telephone line, coaxial cable, Bluetooth connection, etc. Users of the system 100 may be required to register with the game server 104. In such an instance, each user may choose a user identifier and a password which may be required for the activation of services. The user identifier and password may be passed across the Internet 108 using encryption built into the user's browser. Alternatively, the user identifier and/or password may be assigned by the game server 104.

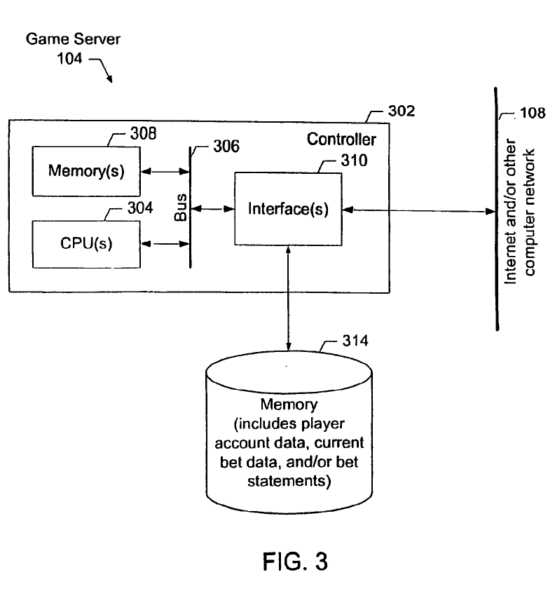

A more detailed block diagram of a game server 104 is illustrated in FIG. 3. Like the client device 102, the controller 302 in the server 104 preferably includes a central processing unit 304 electrically coupled by an address/data bus 306 to a memory device 308 and a network interface circuit 310. However, the sever controller 302 is typically more powerful than the client controller 202. Again, the CPU 304 may be any type of well known CPU, such as an Intel Pentium™ processor, and the memory device 308 preferably includes volatile memory and non-volatile memory. Preferably, the memory device 308 stores a software program that implements all or part of the methods described below. This program may be executed by the CPU 304 in a well known manner. However, some of the steps described in the method below may be performed manually or without the use of the server 104. The memory device 308 and/or a separate database 314 also store files, programs, web pages, etc. for use by the client devices 102.

The server 104 may exchange data with other devices via a connection to the network 108. The network interface circuit 310 may be implemented using any data transceiver, such as an Ethernet transceiver. The network 108 may be any type of network, such as a local area network (LAN) and/or the Internet.

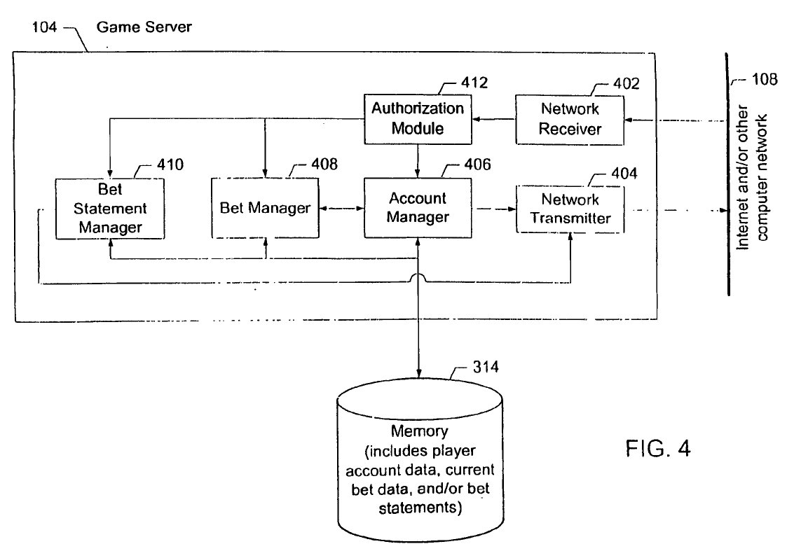

A more detailed block diagram of another embodiment of the game server 104 is illustrated in FIG. 4. In this embodiment, the game server 104 includes a receiver 402, a transmitter 404, an account manager 406, a bet manager 408, a bet statement manager 410, and an authorization module 412. Each of these blocks may be implemented by a microprocessor executing software instructions and/or conventional electronic circuitry. In addition, a person of ordinary skill in the art will readily appreciate that certain blocks may be combined or divided according to customary design constraints. Although the wagering system is described herein as client/server based, a person of ordinary skill in the art will readily appreciate that a stand-alone version of the wagering system may also be used. In such an instance, the operations described below as being performed by the game server 104 may be performed locally by a client device 102.

For the purpose of receiving web page requests, player account data, bet statements, bet data, user names, passwords, and other data, the game server 104 includes the network receiver 402. The network receiver 402 is operatively coupled to the network 108 in a well known manner. For example, the network receiver 402 may be an Ethernet interface circuit electrically coupled to the Internet via an Ethernet cable.

Player account data preferably includes account numbers and associated point totals. In some embodiments, the points may represent money. For example, 0.01 points may represent one penny or one dollar. Alternatively, well known credit card accounts may be used. Bet statements are preferably text based statements that indicate what the bet is (e.g., “Madonna will win a Grammy in 2001”). Bet statements may be selected from a database of bet statements by the players, and/or bet statements may be entered by the players. Bet data preferably include one or more risk percentages, position indicators, and outcome indicators. For example, player one may indicate that he thinks there is a 60% chance that Madonna will win a Grammy in 2001 (risk percentage=60%). Player two may take the “positive” or “yes” position (i.e., player two thinks there is at least a 60% chance that Madonna will win a Grammy in 2001), thereby forcing player one into the “negative” or “no” position (i.e., player one wins if Madonna does not win a Grammy in 2001). Preferably, players take turns setting risk percentages and selecting bet positions (e.g., player one sets the risk percentages for odd numbere that Madonna does win a Grammy in 2001 (outcome indicator=positive), then player two wins. However, player two only wins 0.4 points (or some near multiple thereof), because player two was favored to win. On the other hand, if player one wins (Madonna does not win a Grammy in 2001), player one will receive 0.6 points (or some near multiple thereof), because player one was not favored to win.

For the purpose of transmitting web pages, player account data, bet statements, bet data, and other data, the game server 104 includes the network transmitter 404. The network transmitter 404 is operatively coupled to the network 108 in a well known manner. For example, the network transmitter 404 may also be an Ethernet interface circuit electrically coupled to the Internet via an Ethernet cable.

For the purpose of storing player account data, bet statements, bet data, user names, passwords, and other data, the game server 104 includes a memory device 314. Preferably, the memory device 314 is operatively coupled to the account manager 406, the bet manager 408, and/or the bet statement manager 410. The memory device 314 may be a single memory device or a combination of memory devices. The memory device 314 may be volatile memory, non-volatile memory, or a combination of volatile and non-volatile memory. The memory device 314 may be a local memory device, a remote memory device, or a combination of local and remote memory devices. For example, player account data may be stored remotely at a financial institution or locally as points. Bet statements may be stored in a database located near the game server 104, and/or bet statements may be stored in a memory associated with one or more clients 102.

For the purpose of managing account data associated with a plurality of players, the game server 104 includes the account manager 406. Preferably, the account manager 406 is operatively coupled to the transmitter 404, the receiver 402, and the memory device 314. Preferably, the account manager 406 stores/retrieves player account data to/from the memory device 314. After each round of betting, the account manager 406 awards points. In one embodiment, the account manager 406 subtracts points from a player account associated with a losing position and adds the same number of points to a player account associated with a winning position. In addition, the account manager 406 may cause the transmitter to transmit the player account data over the computer network 108. For example, after a round of betting in which player one lost and player two won, the account manager 406 may subtract a certain number of points from player one's account, add those points to player two's account, transmit player one's new account status to a client device 102 associated with player one (e.g., update a web page for player one), and transmit player two's new account status to another client device 102 associated with player two (e.g., update a different web page for player two). Of course, both player's could be sent the same information or both players could be at the same client device 102.

For the purpose of managing bets between players, the game server 104 includes the bet manager 408. Preferably, the bet manager 408 is operatively coupled to the receiver 402, the memory device 314, and the account manager 406. Preferably, the bet manager 408 receives a first risk percentage from the receiver 402 and then determines a second risk percentage such that the sum of the first risk percentage and the second risk percentage is equal to 100%. For example, if the first risk percentage is 75%, then the second risk percentage is determined to be 25% by subtracting 75 from 100. The bet manager 408 may then store the risk percentages in the memory device 314.

Subsequently, the bet manager 408 may receive a position indicator. The position indicator identifies an association between one of the player accounts and one of the risk percentages. In some embodiments, a player's position is not selected by the player. Instead, the players position is forced by the system. After the event which is the subject of the bet has past, the bet manager 408 receives an outcome indicator from the receiver 402. The outcome indicator identifies one of the risk percentages as the winning position. The bet manager 408 may then cause the account manager 406 to subtract an amount from the losing player's account and add that amount to the winning player's account. However, in some embodiments, points are not necessarily subtracted from an account. Preferably, the bet manager performs these tasks for a series of bets (i.e., a game).

For example, player one may place the odds at 60%, which indicates that he thinks there is a 60% chance that Madonna will win a Grammy in 2001 (risk percentage=60%). Player two may take the “positive” position (i.e., player two thinks there is at least a 60% chance that Madonna will win a Grammy in 2001), thereby forcing player one into the “negative” position (i.e., player one wins if Madonna does not win a Grammy in 2001). If the actual outcome is that Madonna does win a Grammy in 2001 (outcome indicator=positive), then player two wins. As a result, 0.4 points (or some near multiple thereof) are subtracted from player one's account and added to player two's account.

For the purpose of managing bet statements, the game server 104 includes a bet statement manager 410. Preferably, the bet statement manager 410 is operatively coupled to the transmitter 404, the receiver 402, and the memory device 314. Preferably, the bet statement manager 410 receives bet statements from the receiver 402, stores the bet statements in the memory 314, retrieves the received bet statements and/or “canned” bet statements from the memory 314, and causes the transmitter 404 to transmit one or more bet statements over the computer network 108. Bet statements are preferably text based statements that indicate what the bet is (e.g., “Madonna will win a Grammy in 2001”). Preferably, bet statements are complete sentences stated in the positive (as opposed to negative or double negative statements). In addition, bet statements are preferably unambiguous with a clear easily determined, quantifiable outcome. Bet statements may be selected from a database of “canned” bet statements, and/or bet statements may be entered by the players. In one embodiment, the players simply keep track of the bet statements orally and/or with the aid of a written record. In such an instance, the bet statement manager may be eliminated.

For the purpose of providing security to player account data, the game server 104 includes an authorization module 412. The authorization module 412 is operatively coupled to the receiver 402, the account manager 406, the bet manager 408, and/or the bet statement manager 410. The authorization module 412 receives a user name and/or password from the receiver 402 and determines if the user name and/or password is associated with a player account.

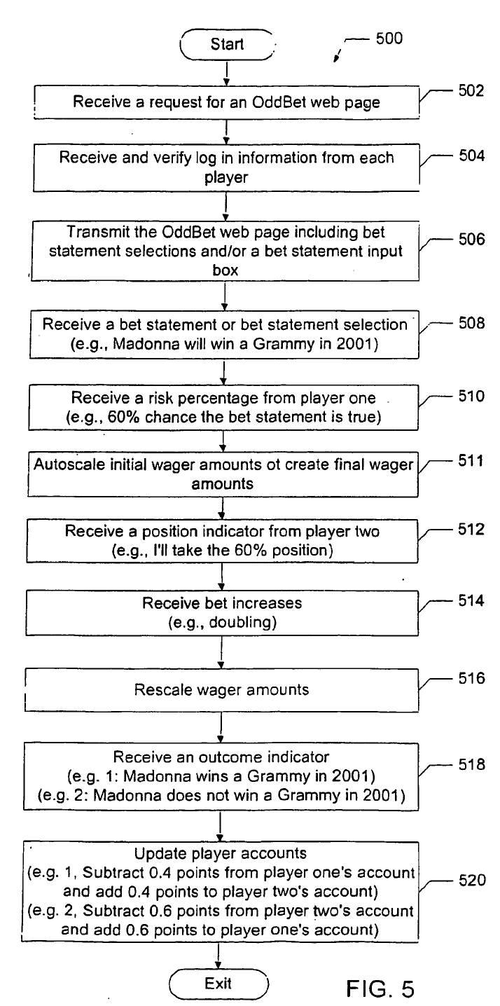

A flowchart of a process 500 for facilitating fair peer-to-peer gambling is illustrated in FIG. 5. Preferably, the process 500 is embodied in a software program which is stored in the game server memory 308 and executed by the game server CPU 304 in a well known manner. However, some or all of the steps of the process 500 may be performed manually and/or by another device. Although the process 500 is described with reference to the flowchart illustrated in FIG. 5, a person of ordinary skill in the art will readily appreciate that many other methods of performing the acts associated with process 500 may be used. For example, the order of many of the steps may be changed. In addition, many of the steps described are optional.

Generally, the process 500 receives a bet statement from one of two authorized players (e.g., “Madonna will win a Grammy in 2001). Either one of the two authorized players then enters a whole number percentage representing his belief that the outcome of the bet statement will be true. For example, player one may indicate that he thinks there is a 60% chance that Madonna will win a Grammy in 2001. The player entering the risk percentage is encouraged to be as fair as possible, because the other player chooses which side of the bet he will take. For example, player two may take the “positive” position (i.e., player two also thinks there is a 60% chance that Madonna will win a Grammy in 2001), thereby forcing player one into the “negative” position (i.e., player one wins if Madonna does not win a Grammy in 2001). If the actual outcome is that Madonna does win a Grammy in 2001, then player two wins. However, player two only wins 0.4 points (or some multiple thereof), because player two was favored to win. On the other hand, if player one wins (Madonna does not win a Grammy in 2001), player one will receive 0.6 points (or some multiple thereof), because player one was not favored to win. In other words, the reward always automatically and fairly matches the risk as perceived by the odds setter. Although, for clarity in description, only one bet is shown, a person of ordinary skill in the art will readily appreciate that entire games (i.e., a series of bets) may be played according to the method described herein without departing from the scope or spirit of the present invention.

The process 500 begins when the game server 104 receives a request for one or more OddBet web pages from a player via the network 108 (step 502). However, as discussed above, the OddBet system need not be carried out over the Internet if a stand-alone device is used. Some OddBet web pages preferably require a username and/or a password (step 504). Once the server 104 receives the username and password, the server program 500 verifies that the username and password belong to a registered OddBet player by checking the database 314 (step 504). Similarly, a second OddBet player logs in using a different username and password. If the two OddBet players are competing from separate client devices 102,

The server program 500 then transmits one or more web pages to the players for display at the players' client devices 102 (step 506). Preferably, the server program 500 starts by transmitting a “home” page. The home page is typically the top level in a hierarchical collection of related web pages at a particular web site. The majority of these related web pages are typically served from the same network domain (e.g., OddBet.com). After receiving the home page, the clients 102 may request additional web pages from the web site by selecting hyperlinks embedded in previously received web pages in a well known manner. Preferably, at least one of the transmitted web pages includes a plurality of bet statement selections and/or a bet statement input box.

Subsequently, one of the players selects one or more bet statements from the plurality of bet statement selections and transmits data indicative of the selection to the game server 104 (step 508). Alternatively, one of the players transmits one or more complete bet statements to the game server 104. In addition, a bet statement may be associated with an initial wager amount. Alternatively, the initial wager amount may be preset and/or entered separately.

Once one or more bet statements are set, one of the players transmits a risk percentage(s) to the game server 104 (step 510). Preferably, the risk percentage is entered into a web page input box as a whole number percentage (e.g., 1%-99%). The risk percentage is preferably associated with the positive outcome of the bet statement, but may be associated with the negative outcome of the bet statement if so indicated by the player submitting the risk percentage.

Often, an individual cannot tolerate a large loss as easily as a gambling house. Accordingly, the server 10 may automatically and consistently scale the initial wager amount down to a final wager amount as odds grow longer or more extreme (step 511). However, the system maintains a fair risk-reward relationship. In one embodiment, form fields enable players to enter loss cap agreements per bet and/or per game. Preferably, an error message prevents any inputs in the bet process that could result in violation of the player-set loss caps. In this embodiment, the players would have to change the cap field by mutual agreement before the system would enable a bet action that violated the initial cap field setting. As a result of these loss control measures, users waste less time haggling or worrying about setting the payouts (i.e., the stake) or losing more than the player can afford.

The embodiments described herein may use a process of proportionally decreasing the payouts for a wager as the odds become longer (or, in other words, the probability of the bet outcome becomes more extreme). The process, which is referred to here as Risk scaling (or R-scaling) can be done in different ways per player agreement and different versions are illustrated here. The illustrations show that Risk scaling may make the amount of one of the two payouts decrease and/or stay fixed as the probability (the pseudo-odds or “odds”) for the bet grows more extreme. Obviously, one of two payouts in the payout combination must increase as the “odds” grow extreme, but that increasing payout will be less than what it would be if the risk scale was not used. So payout combinations are “decreased” relative to what they would be if Risk scaling was not used. However, R-scaled payouts preferably maintain a fair proportionality as determined by the bet probability so that each payout reward matches the assumed risk. The payout combinations along the probability continuum may decrease in amount at different rates according to the type of R-scale that is used. R-scaling is helpful partly because an individual player does not have the same deep pockets a gambling house does that enable it to cover the occasional large loss when an opponent wins a long shot bet.

R-scaling may occur after some payouts projections are calculated and displayed, but R-scaling preferably occurs as part of the process that calculates and displays the initial payout projections.

In addition, it will be understood throughout the description that the term payout projection or projected payout is sometimes used rather than the term payout to emphasize that a payout is still in a stage of the bet process where it may be scaled or increased or decreased or rejected in some way. The term payout is used throughout the description to refer to payouts that are finalized as well as payouts, that may be just projected but never occur or that are payout projections that are subsequently increased or decreased. Payouts may be projected and displaying at different times in the bet or calculation process to help players follow the process and better understand choices and to keep track of the status or stage of a bet. For example, even before an outcome is entered into a system it is possible to project the payouts for one or more players that would occur if the outcome of a bet is positive and if the outcome was negative. Projections can even be made on a series of wagers. The time at which a projected bet becomes an actual bet may vary within embodiments and projections of payouts may be skipped entirely so that only finalized payouts are displayed.

In addition, it will be understood throughout the description that some amounts may require rounding and that any wager amount may be multiplied by some constant (e.g., $2) without departing from the scope and spirit of the present invention. For example, a final wager amount of 0.75 may represent $1.50.

The straight sliding amount scale Risk scale: This type of scaling dramatically decreases the initial wager amount on bets with long odds. Preferably, the straight amount scale is the default scale, and a good scale for beginners because it is the easiest to understand. At one extreme, the 50% to 50% chance bet has a final wager amount of 0.5 for both players. At the other extreme, a 1% to 99% change bet has a final wager amount of 0.01 for one player and 0.99 for the other player, which means the wager amount is relatively and proportionally far less than the wager amount of a 50% to 50% even bet. Using this scale, the final wager amounts are proportional and match the numerals that represent the opposite side of the odds. For example, the 11% to 89% odds bet has a final wager amount of 0.89 if you were on the side of the bet with only an 11% probability of winning.

The no slide scale: In this option payout amounts do not decrease as the odds grow longer so this is the option where Risk scaling is “disengaged” or, in other words, the option where R-scaling is not used. If a player is on the high (or even) probability (i.e., safe) side of a bet, he will always have a final wager amount of 0.5 points (unless players use their options to increase the bet). This scheme includes 50 different payout amount combinations within a linear progression. At one extreme, the 50% to 50% chance bet has a final wager amount of 0.5 for both players. At the other extreme, a 1% to 99% chance bet has a final wager amount of 0.5 for one player and 49.5 for the other player. 2% to 98% odds create final wager amounts of 0.5 and 24.5. 3% to 97% odds create final wager amounts of 0.5 and 16.17. 49% to 51% odds create final wager amounts of 0.5 and 0.52. (Note that some of the final wager amounts are rounded by a very insignificant amount.)

The factor (e.g., of 10) sliding Risk scale: This type of scaling is similar to the straight sliding amount scale described above, however, the final wager amounts associated with the 1% to 99% bet is multiplied by some factor such as ten. Therefore, the final wager is only 5 times rather than 50 times less than the amount wagered on an even bet. As a result, the losing player loses 0.5 points on an even bet and 0.1 points (or 9.9) on a 1% to 99% bet. Based on the two bet extremes (even and 1% to 99%), and their designated payouts, a mathematical formula may set the final payout amounts for bets on other probabilities (or pseudo odds) in between the two extremes so that the payouts remain proportionally fair.

The player defined scale: To use this scale, an administrator and/or the players must answer two questions during the setup of a game. The first question is “What amount can you comfortably wager repeatedly during a series of even 50% to 50% bets?” The second question is “If you enter a 1% to 99% bet and you lose so that you have to pay your opponent 99 times what you would have collected, what is the amount you could comfortably pay out for such an unlikely large loss?” For example, a player might enter $1 as the average and $20 as the worse loss. How many bets are in the planned series is assumed to already be entered in the system A formula then analyzes the three inputs to recommend a proper scaling method and bet increasing rules.

Either player may determine the bet statement, and either player may set the pseudo-odds (the probability or risk percentage). However, whichever player sets the risk percentage for a particular bet statement (e.g., player 1), the other player determines which side of that bet he will take (e.g., player 2). Accordingly, that player (e.g., player 2), transmits data indicative of his bet position to the server 104 (step 512). Alternatively, player 1 may enter data for player 2. Preferably, the players take turns setting the risk percentage (e.g., player one sets the risk percentage for odd numbered bets). In an alternate embodiment, one or both players may be required to submit data associated with one or more bets prior to a predetermined time limit. In this embodiment, faster players may be rewarded with additional points.

Subsequently, either player may increase the initial wager amount (step 514). For example, the player in the forced position may be allowed to increase the wager amount. In addition, the player in the selected position may be allowed to increase the wager amount (either initially or in addition to a previous doubling). In another embodiment, the players may negotiate one or more bet statements, risk percentages, bet positions, and/or bet increases.

In large group games, players may rank and/or weigh a plurality of bets as part of the stake setting process. In such a large group game, more than one player may take the same bet position. Similarly, more than one player may be forced into the same bet position.

Once the risk percentages and wager amounts are known, the game server 104 may display an error message and/or automatically re-scale the wager amounts to limit a player's maximum loss (step 516). For example, if each percentage point represents two dollars, the odds are set at 60%-40%, and a player has previously indicated that he does not wish to risk more than $100 on any single bet, then the initial wager amount may be scaled from payouts of $80-$120 to payouts of $66.67-$100 respectively. Note, the final wager amounts must often be rounded (as in this example) to keep even dollar amounts. A person of ordinary skill in the art will readily appreciate that although this rounding affects the fairness of the bet to a minor degree, it does not depart from the scope and spirit of the present invention.

Once the event which is the subject of the bet statement has past, one or more of the players and/or a system administrator transmits an outcome indicator to the server 104 (step 518). Preferably, this is accomplished by recalling a record from the server 104 which indicates the bet statement, the risk percentages, and the positions taken. Next to the displayed record, the server 104 provides one button for indicating a positive outcome, and another button for indicating a negative outcome. Of course, a person of ordinary skill in the art will readily appreciate that many other methods of selecting between two possible choices using a web page are well known. For example, a check box may be used.

Once the server 104 receives the risk percentage, the position indicator, and the outcome indicator, the program 500 updates both player's accounts (step 520). Preferably, the number of points subtracted from the losers account is the same as the number of points that are added to the winners account. In other words, there is no “house cut.” In addition, the number of points added to the winner's account is inversely proportional to the risk percentage associated with the winner. Said another way, the number of points subtracted from the loser's account is directly proportional to the risk percentage associated with the loser. A winner who is expected to win (i.e., his risk percentage is greater than 50%) receives fewer points than a winner who wins against the odds (i.e., his risk percentage is less than 50%).

In another embodiment, two or more players compete against a plurality of players by comparing their independent scores. In this embodiment, the same complimentary odd setting and scoring methods are used except that points deducted from a player's score (i.e., account) are not then added to the score of an opponent. Similarly, points added to a player's score do not come from another player's score. In small group games, one or more of the players may serve as an administrator. Preferably, in large group games, a game administrator from the company that is providing the game service is used. The game administrator could set all bet statements and odds, or the players could play a role in setting bet statements and/or odds.

Players select their bet positions independently. Accordingly, more than one player may have the same position on a bet. Preferably, after choosing positions, a player in a large group game ranks his bets from best to worst. A more substantial relative bet increase or weight is then assigned according to ranks. For example, if there are 10 bets in the game the player rates the bet he likes the best a 10, the bet he like second best a 9 and so forth. The initial wager amount for the highest ranked bet is then multiplied by 10 (which is the player's assigned rank). The initial wager amount for the second highest ranked bet is multiplied by 9, and so on. Even if two players have identical positions on a series of bets, the rank and weighting system means that their scores could be far different. Final scores are the basis for determining a winner.

A unique, dynamic, streamlined accounting method and apparatus of wagering that includes a process for determining fair wagers and automatically scaling wagers amounts to fit the needs of the players so that it is less likely that they will accidentally wager more than they can afford is disclosed above and in U.S. Ser. No. 09/840,574 filed Apr. 23, 2001 which is incorporated herein by reference. Although any of the scaling and accounting methodologies described therein could be applied to the present methods, the illustrations in the present application will use the straight sliding amount type of R-scaling.

Choosing bet positions is often based on the odds, so it is useful for players to know the odds. However, choosing a bet position may be easier than setting odds, because selecting the bet position involves only two distinct choices while setting the odds involves a far wider range of similar choices. It would be nice if all the players in a group wager were able to do the more challenging, engaging activity of setting the odds but no one has developed a sensible way.

Typically, gambling operations, such as casinos, set the odds, and the player can accept or decline one side of the bet. However, gambling operations typically do not allow each player to set and play their own odds with an incentive to do so in good faith so that the players cannot gain an unfair advantage. A gambling operation does not want to give a customer the choice of which side of a bet to accept using the same odds because then making a profit may require a fee system or revenue other than the net revenue gained through giving “unfair” or “unfavorable” odds.

The FOA and IOA and MOA

Before describing the present method two definitions are provided. The protocol for expressing odds is to use a one or two digit whole number (e.g., 1 through 99) to indicate the chance for a positive outcome in a bet statement that is expressed in a positive format. The fair odds assessment (FOA) is “odds” (or probability) that are assigned to a bet that are then compared to the odds that an individual assigns to the bet, which are referred to as the individual odds assessment (IOA). An IOA is what a player submits as his odds assessment (e.g., a probability assessment expressed as a one or two digit whole number). In several embodiments of the method, the comparison or relativity of FOA and IOA is the basis for determining the side of a wager a player is automatically placed in.

The FOA is a piece of data, not necessarily in percentage form, that may be determined using different algorithms, or designations, or combinations of algorithms and designations. Designations can be based on factors of the game or the assessments of the players or related factors outside the game.

The type of algorithm and central tendency calculations used to calculate an FOA may depend on the number of players that are competing. For example ,if only three players are competing, then “average” may be a better basis for calculating the FOA than “mode.” In one embodiment, the method enables providers or players to select and/or customize the FOA determination basis.

The algorithm(s) that determine the FOA may be based on the odds submitted by each of the players for a specific bet statement. In addition, the FOA algorithm(s) may use a central tendency statistical technique or combination of statistical (e.g., average) or non-statistical (e.g., high score) techniques to calculate an appropriate FOA. Still further, the FOA algorithms may use odds data from previous bets and/or a random number generator.

Central tendency techniques include calculating the mean (or average), mode (most common), median (middle), mid-quartile, and mid-percentile. So central tendency techniques and statistical analysis techniques such as determination and use of the standard deviation in a group of data can be used to analyze all the members of the group or they can be used to analyze just the portion of the group that meets certain criteria. Also note that an opponent's odds (IOA) for a bet statement in some embodiments are used as the FOA (or, at least, play a very similar role in bet position determination as the FOA). An alternative is to use a game administrator's or gambling operation's assessment of the odds as the FOA. The administrator could also reserve the right to manually or automatically substitute his or her own odds assessment in place of the calculations on the group data. Another scenario to calculate FOA could have an administrator's odds assessment, and a group-averaged odds (GAO) based on all qualified IOA submissions equally determine FOA. For example, if administrator assesses the odds at 20% and the GAO is 30%, then the FOA is 25% since each of the odds in this example carries the same 50% weight.

Statistical analysis commonly eliminates members of a group that are anomalous or extremely different from other members of a group because analyzing all data in a group, including anomalous data, can generate misleading information. For example, if 10 players estimate odds for abet statement that fall in a range of between 70% and 90% but one player submits odds of just 1%, then the extreme odds can dramatically drag down the group average. The 1% odds submission may be the result of a data entry error or the mean spirited effort of someone that is trying to spoil the game for other players.

Players can gain a certain satisfaction in knowing that they are contributing too and completing against the collective wisdom of the group. Therefore, the FOA may be based on automated and/or manual calculations of data submitted by players so that submissions determined to be anomalous or far removed from the conventional wisdom or norm are excluded from FOA calculations. Non-anomalous IOA's are qualified IOA's.

If an IOA is determined by the established criteria to be unqualified for FOA calculation it does not mean that the player submitting the IOA is not entered into a bet based on their submission. Preferably, the player submitting the unqualified IOA has to face the likely negative consequences of their bizarre submission. Alternatively, the player might not be placed in the bet if doing so gave one of the other players a significant unfair advantage. Frequent unqualified submissions may be a reason to suspend a player's participation.

The middle odds assessment (MOA) is defined as the mean or middle difference between an IOA and the related, determined FOA. For example, if FOA is determined to be 60% and a player's IOA for the same bet is 50%, then the MOA is 55%. MOA is used in some embodiments as the odds for abet. Since an IOA can serve as the FOA, the MOA can also be the mean between two IOA's that are submitted in a two player game.

Embodiment A

For simplicity, the following illustration of embodiment A uses the unqualified group-averaged odds (GAO) as the fair odds assessment (FOA).

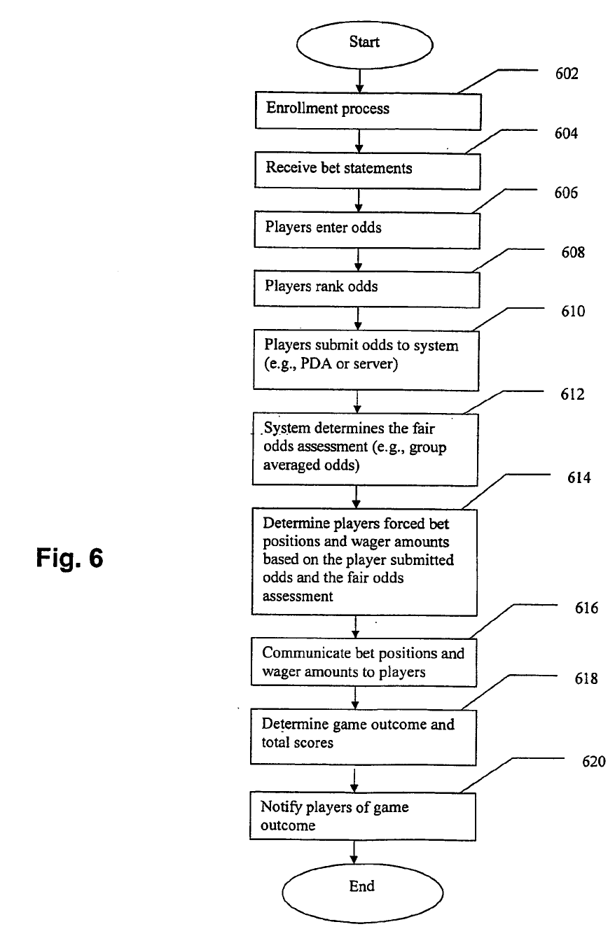

First, referring to FIG. 6, there is an enrollment process which includes an agreement among the players as too whether they are playing for real money, make-believe money, points, and/or prizes (block 602). If the game is played for real money, then there may be an agreement that points represent a certain amount of money, such as 0.01 points equals one cent or one dollar. Preferably, players also agree to rules concerning details, such as how many and/or how prizes are distributed.

Second, each player is sent (or required to obtain) a series of bet statements from a game administrator (block 604). The game administrator could be a gambling operation, machine, and/or one or more of the players competing in the game that are authorized to function as the game administrator. In this embodiment, the players have little or no rights to alter, negotiate, or challenge the appropriateness or fairness of the bet statements and may be required to participate in all the bets. In alternative embodiments, players may be allowed to alter, negotiate, or challenge the appropriateness or fairness of the bet statements In addition, players may decide not to participate in certain bets. Bet statements are preferably stated as a positive and have a clearly defined outcome within an appropriate time frame.

Players can submit a proposed bet statement for approval (e.g., by an administrator) and inclusion in a game, or players can request a bet statement in a certain subject matter be included in the game. Players may be awarded bonus points for accepted bet submissions.

Third, each player sets the odds (e.g., a one or two digit whole number) for every bet statement in the game (block 606). Each player is setting the odds for their own bets. Odds setting is preferably done in secret so each opponent within a group does not know what each other opponent's odds are until after they have all submitted their odds for each bet.

Fourth, each player ranks their odds assigned to each bet (or bet statement) in the order of attractiveness from best to worst even though they do not yet know which side of the bet they are on (block 608). Attractiveness is a rather subjective assessment of the confidence a player has in the accuracy of his IOA relative to his IOA for the other bet statements, and possibly what the player suspects will be the odds submitted by other players. This ranking stage could be skipped to streamline the method. However, ranking does require skill and it may make ties or extremely close scores less likely.

A more substantial relative bet increase or weight is then assigned according to ranks. For example, if there are 10 bets in the game the player rates the bet odds he likes the best a 10, the bet odds he likes second best a 9 and so forth. The initial projected fair win or loss points that the player has riding on the bet he likes the best are then multiplied by 10 (which is the player's assigned rank of the bet). The initial fair return or loss points the player has riding on the bet he likes second best are multiplied by 9, and so on.

The ranking-weighting system is preferably a substitute for the more flexible bet increasing system used by one-on-one two player embodiments. Players in a large group game are preferably not allowed to arbitrarily increase their bets as they do in the head-to-head, player-to-player game. A large group games benefits from consistency because players compete through total scores so that there is no transfer of points from one account (or score) to another account.

The ranking-weighting system is an example of how the order of certain stages can be changed and how certain stages can be eliminated (or added or altered). In another embodiment, the game may be played without the weighting/ranking of the bet odds stage. In another embodiment, the ranking-weighting may be performed after the players know what positions in the bets they are forced to assume.

Continuing on, the fifth stage is for the players to submit to the administrator's server (or system) the odds for each bet statement (block 610). In the sixth stage, the FOA (in this case, the group-averaged odds or GAO) for each bet statement is then calculated based on the player submissions (block 612). Preferably, FOA is kept secret from the players, at least until all the bets are in and no more are accepted.

The player's submitted odds are used as just the odds for that one player's bet. The process makes the player's own odds the basis for calculating the player's wager amount and their own loss or gain on the wager.

So, FOA (in this case, the group-averaged odds or GAO) reflects the collective conventional wisdom of the group and is used to determine a player's position (or side) in a bet that uses the player's own odds (IOA). In other words, the player is encouraged to give fair odds because he or she is forced into the side of the bet that is least attractive according to the group-averaged odds and how it compares to the player submitted odds.

To illustrate, suppose the bet statement is the ‘Yankees win the division’, and the group-averaged odds (of a positive outcome) are 55% and a player's submitted odds are 65%. Using the player's submitted odds, the group on average prefers the long-shot negative outcome position (Yankees lose division). Therefore, the player is forced to bet ‘Yes, Yankees win’ at 65% odds, which means he can lose 0.65 (points, dollars, etc.) but can only win 0.35 (points.dollars, etc.). If the player submitted odds of 40%, he would be forced to bet ‘No, Yankees lose’ at 40% odds so that he wins only 0.40 (points, dollars, etc.) if the Yankees fail and loses 0.60 (points, dollars, etc.) if the Yankees win, which is unlikely according to his own odds.

To continue with the embodiment's process, the seventh stage, as just illustrated, is for each player's position on each bet to be determined by comparing the IOA (the player's submitted odds) with the FOA (in this case, the group-averaged odds) for the bet (block 614).

The eighth stage is to communicate to each player what bet positions the player has been forced into (block 616). This could be done for example, by sending the player an e-mail or by notifying them during the rules stage that they may to access such information on a web site after a specific time. Players could also be provided with other information or the ability to obtain more information about their bets as well as the bets of their opponents. For example, it might be interesting to find what is the maximum amount of points each player could win.

Providing additional information helps players to understand what scenarios of bet outcomes will be most beneficial to them, and understanding that makes observing bet outcomes such as a football game more interesting. However, it is not essential that this communication occur for the process to work. It might be advantageous for the provider of such a system to keep the FOA for each bet a secret, but in this embodiment it is part of the information shared with players.

Ninth, outcomes are determined per the rules and entered into the system. The player's scores are then totaled (block 618). Total scores of the players are then compared to determine the order of finish in the contest.

Tenth, players are notified or otherwise given access to the outcomes of their wagers and their resulting scores, as well as to the results of other players (block 620). Which player or players are declared the winners is also communicated.

When the IOA submitted by a player is equal to the FOA then the preferred way to place the player on a side of the bet is to use a random decision generator, although the decision could also be delegated to the administrator of the game or influenced by player statistics such as the player's total score.

Over the course of many bets, a player would have to be very good at odds setting to generate a positive total score while playing Embodiment A because he is always being forced to bet against conventional wisdom. Yet, all players face the same challenge so it is a fair game. Players are always getting a fair bet according to their own perception of the risk.

Computers can automate the process of comparing each player's IOA to the FOA, so the game could be played by an enormous amount of players or just two players. A player is not confused by the myriad of odds because the only odds the player must know (and play) are the odds he or she sets. In a two-player version of Embodiment A, the preferable FOA is just the odds set by the opponent rather than the average of the two players odds.

Embodiment A can work as a small group game among friends that is administrated by one or more of the participants. Embodiment A also works well when large groups of individuals are playing for prizes or when each individual in the large group is gambling real money against a house.

One important issue is that odds evolve as the factors that determine a bet statement evolve, and it is fairly common for odds to change suddenly and radically, as might happen if a player is suspended right before a wagered game. Yet fairness is maintained as long as everyone has the same odds submission due date and time, since this means people face the same opportunity and risk. Allowing players to change odds submissions is an expensive and difficult undertaking. The preference is to stress that any submission is final and explain to people that waiting until right before the due date to submit has advantages. Alternatively, players could also be given a small point reward as an incentive for submitting odds well before a due date.

Preferably, the “final” FOA for a bet is only calculated once very soon after the submission due date and using all qualified submissions. IOA's are compared to that one FOA figure. An alternative embodiment calculates and keeps a “running” FOA that evolves as the early submissions get entered into the system. The early IOA submissions could then be compared to the evolving FOA and get placed in a bet with the FOA at that time. Players that submitted their odds at the last moment would be entered into a bet with the most recent FOA so there would be less advantage to waiting until the last moment to submit IOA's. Players could be notified of their positions soon after they make an early bet or all players could be notified of their positions after the bet due date.

GAO could be used as a single mutual FOA when just two players play embodiment A. However, a more understandable way to achieve the same effect is to use the opponent's IOA as a position forcing criteria that can serve in a manner similar to the FOA. In this embodiment each of the two players has a separate FOA.

Embodiment B

An alternative embodiment B, which is preferably played between just two players, enables players to choose their position on every bet. Embodiment B insures that two players can both be given a bet that is more than fair according to their own perception of the odds, with one unusual exception If both players quote the same one or two digit whole number as the odds then the bet arrangement each player gets is just perceived as fair, rather than more than fair.

The way that this is accomplished is to have the two players each set odds on the same bet just as in Embodiment A. But instead of making one bet they actually, at least in one sense, make two simultaneous bets on one bet statement so that they are always on the side opposite of their opponent in both of the “two” bets. However, the odds for the “two” bets are different, unless the players, set identical odds.

Emotional factors, such as always betting on the hometown team to win, can influence how people bet. But how a person perceives the odds is an objective, dominant determinant of how the person will bet. If two persons estimate odds on the same bet, then one person's odds tells you what position he would favor based on the other person's odds and visa-versa. The only time this is not true is when the odds estimates of the two people are identical, in which case they are indifferent to which side of the other person's bet they prefer. As long as the two odds estimates are different, then the two players will always, according to their perception of the odds, see one side of their opponents bet as being more than fair.

In embodiment B, each player's own odds serve as the FOA for their opponent's IOA. The system then assigns each player a position in each of the two simultaneous bets. In this embodiment, the system, by its nature, always places the two players on opposite sides of both bets, except when the two players set identical odds.

To illustrate, assume that the bet statement is that, “The Packers beat the Bears”, and that the standard scaling format described above is used to determine the initial point scores. Player Xavier sets the odds at 65% and player Yolanda sets the odds at 70%. Both favor the Packers, but relative to each other, Xavier prefers the Bears more, and Yolanda prefers the Packers more. If the Packers win, Xavier will lose 0.3 on one bet and 0.35 on the other bet. Yolanda's score or account will increase by 0.65 while Xavier's score or account decreases by the same 0.65 amount.

If the two players do quote the same odds then a means other then FOA (in this case the other player's odds), may be used to place the players in a bet position. The preferred method is to automatically place the player who has the highest total score in the yes (or positive) position when the odds are 50% or more. If the odds are less than 50% the score leader is placed in the no (or negative position). This placement might give the player who is behind a better chance to catch up by winning a long shot bet. The score leader is preferably placed in the same position on both of the two bets to remain consistent with how the game is played when the players do not set identical odds.

If the score is tied or the IOA are both 50% than the preferred tiebreaker doesn't work, so a random choice generation algorithm is then used to place the players in a bet position. Sections on other embodiments describe other means of placing players who set identical odds. However such ties are resolved in a two-player contest, in this embodiment the players must be placed in the same side in each of the two bets.

In the following embodiment B illustration, assume:
The two players are physically in the same location (but they could be far apart)
The two players are using the method as an application on a Personal Digital Assistant (PDA) platform.
Play is in a sequential, one-bet-at-a-time fashion (as opposed to creating a series of bets all at once before outcomes begin to occur).

The interface and application let the first player enter their IOA (individual odds assessment) secretively so that the opponent cannot use the application to discover the player's IOA until after the opponent's own IOA is irrevocably entered. The first player is responsible for entering their IOA without providing the opponent with any visual or physical tip off. For example, entry should not be done while the opponent is looking over the player's shoulder. Preferably, the opponent also enters their odds in secret but that is not essential. After the odds are both entered the application is prompted to display the two IOA's. The resulting bet positions are also indicated, preferably, by using both text and a graphic representation. The process and interface is preferably designed to make it seem like there is only one bet when in reality there are two and the results are just combined to generate the single amount that one player wins from the other.

In embodiment B, bet specifics are largely determined only after the player is locked into a bet, but the players can still trust the embodiment to give them a more than fair bet (except when IOA's are identical). Preferably, the system displays the two IOA's, the resulting bet position placements, and potential scoring at the same time. This is a stark contrast to traditional wagering where bet specifics are known before the bet is finalized.

Traditional wagering often lets player's simply not wager after they team the specifics (position, odds, amount, etc.) of a wager, or otherwise fold, or decrease the wager amount. In contrast, part of the excitement here is that the players are preferably locked into the bet. They cannot back out of the bet or decrease the wager amount when they learn the specifics of the bet such as their opponents IOA.

Alternatively, embodiment B (or any embodiment) could have one “player” be a system/machine. The machine would set its IOA to match the FOA of a different group game, from embodiment A for example, that contains the same bet with the same time frame. In a sense, this means an individual human opponent is not required to play embodiment B.

Embodiment B can be played on one bet at a time or on several concurrent, simultaneous bets. It can be played using a variety of systems or platforms but it works particularly well when two players are in the same physical location, which improves communication and socializing. The variety of bet subject matter that can be used increases when players are in the same physical location in part because both players can verify and easily agree to bet outcomes. However, Embodiment B may also be played over the Internet.

Embodiment B works in either the concurrent or sequential formats that are described herein. Concurrent bets are set up at the same time and outcomes can occur in overlapping time periods. In a sequential format, one bet is made and the outcome is completed and accounted for before the next bet is made. Sequential bet formats are best played when the players are together because there is no latency or delay as information must travel over far distances. In embodiment B, “one bet” refers to a bet which can be composed of a plurality of sub bets on the same bet statement that are then added together.

Embodiment G

Embodiment G shows how embodiment B can adjust for play by more than two players. The following illustration using three players maintains the proportional zero sum point system where debit and credits to accounts always counter balance. Of course, any number of players may be used. At the start of the game, the three players all start with zero points Their individual scores turn positive and negative, but at the end of the game the three scores add up to zero. As a result, it is clear which players have won and lost money and how much the loser(s) must pay the winner(s). There can be one winner and two losers, or two winners and one loser. In addition, two or more players may tie.

A proportional point system is achieved by having each of the three players place four wagers on one bet statement. The four bets consist of each player placing a bet using the odds of each of their two opponents and each of the two opponents placing a bet using the player's odds.

Assume that the bet statement is that the Microsoft stock will rise above $100 per share sometime before the end of the year Xavier sets odds at 60%, Yolanda sets odds at 70%, and Zoie sets odds at 80%. Preferably the FOA for each of the sub bets is the relative odds of the opponent.

Based on her odds, Zoie likes Microsoft's chances more than the other two, so she gets her relative overall preference of being placed in all four bets in the position that wins on a positive outcome. The two bets that use her opponent's odds give her more than fair odds (according to her perception of the odds). The other two bets, which use her own odds, are just fair according to her perceptions.

Xavier likes Microsoft's chances to reach 100 the least so she also gets her relative preference of being placed in all four bets in the position that wins on a negative outcome. Like Zoie she has better than fair odds (according to her relative perception of the odds) on two of the bets and fair odds on the other two bets (where she set the odds).

According to her odds, the relatively ambivalent Yolanda winds up in the middle, but she also gets her overall preferred position against the other two players. In her two bets against Xavier she gets her relative overall preference to win on a positive outcome. In her two bets against Zoie she gets her relative overall preference to win on a negative outcome.

In summary, each player bets the other two players two times, one time using their odds and the other time using the opponent's odds, which will almost always be relatively more than fair. The only exception is when players set identical odds which are just fair but not better than fair. Ways to force bet positions in the case of two or more identical odds is explained in other embodiments.

If there is a positive outcome where Microsoft does rise above $100 per share by year's end, then the scoring is calculated as follows: Xavier's four bet scores are −0.4, −0.4, −0.3, and −0.2 for a total of −1.3 points. Yolanda's four scores are −0.3, −0.2, 0.4, and 0.3 for a total of 0.2 points. Zoie's four scores are 0.4, 0.3, 0.2, and 0.2 for a total of 1.1 points. Zoie's 1.1 winnings and Yolanda's 0.2 winnings equal Xavier's loss of −1.3.

If there is a negative outcome where Microsoft does not rise above $100 per share by year's end than the scoring is calculated as follows: Xavier's four bet scores are 0.6, 0.6, 0.7 and 0.8 for a total of 2.7 points. Yolanda's four scores are 0.7, 0.8, −0.6 and −0.7 for a total of 0.2 points. Zoie's four scores are −0.6, −0.7, −0.8, and −0.8 for a total of −2.9 points. Xavier's 2.7 winnings and Yolanda's 0.2 winnings equal Zoie's loss of −2.9.

While embodiment G is actually four bets it is easy for the players to conceptualize it or think of it as just one bet since there is only one bet statement and one total (combined) score for each bet win and loss. Conceptualization is easiest for the two players with the odds that represent one of two polar extremes.

The two players at the polar extremes enter two bets on their own odds that are identical in odds, amount and portion, but different bets in that one of the bets is (at least conceptually) against one opponent while the other identical bet is against the other opponent. The term “against” reflects how points are proportionally won and lost between the two players, but since three players are involved in the total scoring such concepts become more abstract. The player with the odds in the middle enters two bets, which use the middle players odds, but the middle player takes a different position in the two bets.

When embodiment G is played with three players there are six bets on a bet statement, and each player is in four of the bets. When there are four players then there are 12 bets on a bet statement and each player is in six of the 12 bets. In other words, each player enters two bets with each other player. Alternatively, embodiment G can incorporate the Middle Odds Average process defined in embodiment J to reduce the number of bets made.

Alternatively, players can be given greater choices and options such as increasing wager amounts or declining bets without departing from the underlying method. An example of such variations is to let the player that has odds in the middle of the bet to choose his or her bet position. Additional variations are described in the following embodiment H.

Embodiment H

Embodiment H demonstrates use of the present method in variations somewhat similar to G. 1n embodiment H different formats and scoring versions can simplify calculations but they produce scores that do not balance out so that one player's loss is always another players gain and visa versa. Such formats are still fair because they still proportionally relate risk and reward and because all players initially face the same risk and opportunities.

Yet such games cannot in an understandable, effective manner have losers paying winner on a per point basis. Games or scoring systems that lack the proportionality where in one player's loss always matches another player(s) gain must be rewarded in manners that are, in a sense, less proportional and inter-related.

For example, whoever finishes with the highest amount of points could be declared the winner and rewarded $100 regardless of how many points they actually acquired. Another example would be to have players agree to pay off an amount per point of difference between their scores.

The following is a three-player illustration that is very similar to the illustration in embodiment G, but the difference is that each of the players has only three bets on the bet statement rather than four. There are only four bets because instead of betting on their own odds twice they just bet on their own odds once, and in a way so that the resulting point gain or lost only effects the score of the player who set the odds, and so that there is not a corresponding gain or loss in the score of one of the opponents.

In this embodiment the players are forced into positions by comparison of their relative preferences as indicated by their odds. Yet for the player with the odds, in the middle, using this means of forcing does not clearly determine which position the player is to be forced into. Preferably, in this case, the odds that are closest to the odds of the middle player are used to force the player's position. When the odds on either side are equally close, then a random generation algorithm forces the position. For example, Yolanda may be forced into the negative position where the Packers lose, which means that she loses −0.3 in the scenario where the Packers win.

In the example above, if there is a positive outcome where Microsoft does rise above $100 per share by year's end, then the scoring is calculated as follows: Xavier's three bet scores are −0.4, −0.3, and −0.2 for a total of −0.9 points. Yolanda's three scores are 0.4, −0.3, and −0.2 for a total of −0.1 points. Zoie's three scores are 0.4, 0.3, and 0.2 for a total of 0.9 points. Note that because the points do not always transfer from one player to the other that the score of the winner(s) does not necessarily match the score of the loser(s). Yet the scores can be close to matching up.

However, in this example, the scores are only off by −0.1. A formula or assignment may be used to deal with the remaining amount. For example, a formula could proportionally assign such a remaining amount to the players according to winnings and losing of points on the bet. The system could automatically assign responsibility for paying off the remaining amount to the player that loses the most on the bet.

Many variations become possible when there is no attempt to have one player's loss always correspond to another player's gain. For example, each player in the three-player illustration could just do two bets so that one bet is on one opponent's odds, the other bet is on the other opponent's odds, and no bet is placed on the player's own odds. Yet this does not enable zero-sum scoring where one player's win is another player's loss.

In a sense, the player in the middle always faces the boring situation of winning one bet and losing one bet, which can largely cancel out the two bets. Preferably, the player or (layers) in the middle can automatically have their relatively smaller win or loss multiplied by a factor, such as a factor of two, so that the amount they are risking or wagering is more similar to the amount that their opponents are risking or wagering. Such a modification is easier to do in a game where there is not an attempt to have one player's gain always correspond to another player's loss.

Embodiment I

Particularly well suited for play over the Internet, Embodiment I is similar to embodiments described herein. In this embodiment, one of the two players simultaneously plays a plurality of different games and each game is against different player(s). Preferably, the player that is simultaneously playing a plurality of opponents is a celebrity, whose popularity helps to increase interest and participation. Embodiment I is more practical in the previously defined concurrent format rather than a sequential format.

Even though a regular non-celebrity playing against a celebrity may know that the celebrity is actually playing such a game with many other players, there is a genuine feel and fantasy of customized interaction primarily for three reasons. First the regular player is customizing all their information. Second, the regular player knows he is competing against the celebrity's real IOA's. (The competition is real even though the interaction is not really customized and personalized.) Third, it seems like the celebrity player has a direct awareness of the regular player's IOA since the IOA's of the celebrity and the regular both shape the bet odds and influence the bet positions.

Chat or e-mail communication between players competing in games over the Internet may be used. Celebrities may develop messages about specific bet subject matter in advance of the game. Players that win may get a different message from the celebrity than the players that lose.

The celebrity player can simply submit IOA's (odds) for one or a plurality of bet statements to simultaneously and actually play a plurality (e.g., 100,000) of separate distinct games of different formats.

The concept of a celebrity simultaneously playing different players in separate games can also be applied to other embodiments when there are a plurality of celebrities involved. For example, three-player embodiment G could involve two celebrity players (whom preferably have some meaningful relationship with each other) and one regular player. Or, two regular players, who preferably are close friends, could play one celebrity in a pseudo real interaction one-on-one-on-one game. Here again, the celebrity could actually be a real player in a plurality of simultaneous games consisting of at least some of the same bets.

The celebrity in this embodiment is setting the odds. Therefore, one celebrity could be simultaneously playing in both three player and two player games that use the same bet statement. This means that if a plurality of celebrities are playing, the regular players could “mix and match” or choose which celebrities they would like to compete against on a per game (bet series) basis or on a bet-by-bet basis.

In addition, embodiment I (and some other embodiments) enables celebrity opponents to vary from one bet to the next. Playing against different celebrities on each bet has a different type of appeal than playing against just one. A bet can have just one celebrity submitting an IOA for it or there could be several celebrity odds setting (IOA submitting) opponents for a player to choose from. Of course, a celebrity could determine the FOA's for bets used in large group game embodiments described herein.

Embodiment C

Embodiment C increases a player's chances of obtaining more-than-fair odds, and also adds a new benefit of making it easier for players to win a higher percentage of their bets. Preferably, three or more players compete in embodiment C.

A bet in a three-player game illustrates embodiment C. Three players submit odds to the system, which determines an FOA. Again, assume for simplicity that the FOA is the unqualified group-averaged odds. The system then identifies which player's odds are the farthest away from the FOA. These odds are called the bucking odds and the player that submits them is called the bucking player or the bucker.

If two players are tied in terms of being the farthest away from FOA (or the group averaged odds or GAO), then, preferably, a random choice generating subroutine determines which of the tied odds is the bucking odds. An alternative is to have the player with the lowest or highest score be designated the bucker.

When the bucking odds are determined, the bucker enters a separate identical bet with each of the two opponents where the bucking odds are used and the two opponents are placed on the side favored by the FOA. The bucker is placed on the side that bucks conventional wisdom.

Typically, the bucking odds are a poor reflection of the real probability of an outcome, because they buck conventional wisdom. Assuming that the players have identical abilities they will, on average, beat the bucker one-third of the time. However, the other two-thirds of the time they have excellent odds, so their bet winning percentage increases.

Scoring is done in a zero-sum manner. The bucker (who has, arguably, and on average, less attractive odds) is always betting roughly twice as much as the other two players because he is playing two identical bets, where each of his opponents are only playing one of the two identical bets. In other words, while the bet winning percentage goes up, players do not necessarily achieve a higher overall point score because their average loss amount per loss on the less attractive bucker odds increases significantly.

Embodiment C involves the bucker entering one bet with each of the two opponents. An alternative could incorporate the embodiment B process of having two bets placed on the same bet statement where the odds of each of the two players in the bet are used as the odds for one of the bets. In that case, the bucker would be entering two bets with each of the two opponents for a total of four bets.

Embodiment D

In contrast to “fair” odds, the “real” or “actual” odds of a bet can only be calculated with certainty for simple bets such as a coin flip where the real odds are 50%. For complicated bets, even after thorough analysis, the exact real odds can only be speculated and remain a matter of perception.

However, as described earlier, a fair odds assessment (FOA), which represents conventional wisdom, is on average a relatively reasonable approximation of the real odds. Assuming players possess equal skill and knowledge, an FOA, is likely to move closer to the real odds as the number of participants in the group expands.

Embodiment D underscores that some of the fun of the present method is to see who is the best odds setter, and to compare and learn how other player's estimate odds. Comparison is enjoyable whether it is comparing one player's individual odds assessment (IOA) to another IOA, or comparing IOA to FOA.

Embodiment D provides additional reward(s) to players based on how close their IOA is from the FOA on a bet. The closer the player is to FOA relative to the other players, the better their reward opportunity is. IOA's proximity to FOA is referred to as IOAP. IOAP is normally measured in percentages. For example, if the FOA is 85 and an IOA is 80, then IOAP is 5. If the IOA had been 90 the IOAP would still have been 5. IOAP data for each player is preferably tracked and can be reported separately for bets or a game (bet series) even though the final scores are certainly determined in part by IOAP data.

In one embodiment, the player who has the IOA closest to the FOA has the lowest IOAP and therefore gets to play a bet using the (FOA-qualified) IOA farthest away from FOA as the odds, and that player gets to be automatically placed in the bet position that is favored as determined by comparison to his own IOA. FOA-qualified IOA's are IOAs that were not excluded from the FOA calculation because they were extreme. Excluding extreme IOA submissions is used in embodiment D so that a certain player can't get an unwarranted disproportionately large reward.

Ties in distance from the IOA to the FOA or the subsequent FOA to IOA calculation may occur between a plurality of players and are preferably broken by use of a random number generating application. Players are aware of the tie breaking process but it is, of course, automatic and “transparent.” The player with the second closest IOA to FOA gets to use the IOA that is second farthest away from the FOA, and so on.

If there is an uneven number of FOA-qualified IOA's to match up so that each player is matched up with another, then three players may be matched in a two to one arrangement. However, one player need not actually cover two bets or twice as much. The points won and lost in this embodiment are preferably not transferred from one player's score or account to another players score or account. The players are preferably not competing one-on-one; they are competing as one player versus the field.

In an alternative embodiment, players in a tie for the closest IOA to FOA all “play” the same attractive side of a bet. This bet uses the IOA farthest from the FOA for the odds. Players tied for the second closest IOA to FOA all “play” the odds that are second farthest from the FOA, and so on.

Embodiment D rewards players for accuracy in estimating the FOA. There are other ways to match up pairs of players from within a group so that each pair of players enters two bets with each other and where each player's odds are used for one of the two bets as described in embodiment B. For example, the player with the lowest odds (for a positive outcome of a positively worded bet statement) could automatically be paired with a player with the highest odds. The player with the second lowest odds may be paired with a player with the second highest and so on. Players at the polar ends of the “odds spectrum” benefit from this matching, because they are able to place bets that are better than the odds that they perceived as fair. In contrast, players with odds that fall in the middle of the “odds spectrum” are placed in bets perceived as just fair or slightly better than fair.

Roughly Equalizing Score Sizes Across Embodiments

Some embodiments described herein place a player in multiple bets (as opposed to just one bet) on one bet statement. The results of each of the bets are then added together to create a total. This process tends to produce higher win and loss points per bet than embodiments where there is just one bet on the bet statement.

An alternative is to divide the initial wager amounts by the number of bets the player is placed in. Another alternative method is to divide the final score by the number of bets the player is placed in. The division by the number of bets a player has on a bet statement provides a comparable uniformity to the size of the scores in the games regardless of the number of bets each player is placing on one bet statement. For example, in the three-player embodiment G each player may be placed in four bets on one bet statement. In a similar fashion, the initial wager amounts could be divided by four.

In some embodiments with three or more players some players may have multiple bets on a bet statement where two or more of the bets place them in opposite positions on the bet and thus create a hedging or canceling out effect that can lessen the points won or lost. This is not necessarily bad. Again, however, many types of math formulas could largely compensate for this factor and thereby enhance uniformity in bet amounts to enhance comparison of players and competition across embodiments on the basis of average bet score. What is important is the act and process of largely improving per bet scoring uniformity across embodiments not the exact or even approximate formula that is used to accomplish the process.

The Canceling-Out (Averaging) Effect

Before explaining a “canceling out” effect, it is instructive to look at embodiment B from a different view. In embodiment B, having two bets on one bet statement, is similar to averaging the two odds to identify a group-averaged odds (or GAO) that would be between the two odds. One bet (as opposed to two bets) may then placed on the group-averaged odds. However, relative positions and the FOA (opponent's IOA) to IOA comparison are still used to place the players in the wager.

The GAO between the two odds may require rounding. When the GAO is half way between two whole numbers, the rounding could be done in a variety of ways. For example, the odds could always be rounded up, or always rounded down, or rounded up or down based on a criteria, such as rounding toward the player who is winning The preference is to round up or down based on a computer's randomly generated decision.

Setting two odds and playing two bets is similar to placing one bet on the average of two odds. Players might get a misleading, disconcerting sense that this process creates a canceling effect, especially when two players submit odds that are set equal distances from 50% on separate sides of 50%, but the process is fair. The result is that the initial wager amounts (when using the default R-scaling) are both always 1.00. In other words, this produces an even bet. This is true whether the submitted odds are 5% and 95% or 49% and 51%.

For illustration, assume that the bet statement states that, “Our friend Xavier will arrive here by the agreed meeting time of 8 p.m.” Yolanda's IOA is 40% and Zoie's IOA is 60%. Therefore, Zoie wins the bet (or, in a sense, wins two bets) on a positive outcome. The initial wagering payout points on a positive outcome is 0.60 for the bet on Yolanda's odds and 0.40 for the bet on Zoie's odds for a total of 1.00. The payout on a negative outcome is 0.40 for the bet on Yolanda's odds and 0.60 for the bet on Zoie's odds for a total of 1.00. The payouts on a win and a loss are equal (1.00 either way) just as they are on an even bet.

The difference between win and loss points increases as both of the two IOA's move away from 50% in the same direction toward one of the poles. For example, if Yolanda's IOA is 15% and Zoie's IOA is 30%, the IOAP drops from 20 to 15, but the corresponding change in the winning amount only changes to 1.55 or 0.45.

If Yolanda's odds are 51% and Zoie's odds are 71%, then Zoie wins 0.78 on a positive outcome and Yolanda wins 1.22 on a negative outcome. Moving closer to a pole, the point differential increases when Yolanda's odds are 91% and Zoie's odds are 71%. Then Zoie wins 1.62 on a negative outcome and Yolanda wins 0.38 on a positive outcome.

If Yolanda's IOA is 10% and Zoie's IOA is 30%, then Zoie wins on a positive outcome. The initial wagering payout points on a positive outcome is 0.90 for the bet on Yolanda's odds and 0.70 for the bet on Zoie's odds for a total of 1.60. So in a positive outcome Zoie's score (or account) would increase 1.60 while Yolanda's score decreases 1.60. The pay out on a negative outcome is 0.10 for the bet on Yolanda's odds and 0.30 for the bet on Zoie's odds for a total of 0.40. The winning amount is 1.60 or 0.40.

For example, if Yolanda's IOA is 40% and Zoie's IOA is 55%. So IOAP is 15 and Zoie wins on a positive outcome. The initial wagering payout points on a positive outcome is 0.60 for the bet on Yolanda's odds and 0.45 for the bet on Zoie's odds for a total of 1.05. The payout on a negative outcome is 0.40 for the bet on Yolanda's odds and 0.55 for the bet on Zoie's odds for a total of 0.95.

The relationship between the size of two IOA's and the resulting initial win and loss point possibilities is impacted by Risk scaling, which is described herein.

In an extreme situation, e.g., where one IOA is 20% and the other IOA is 80%, then the resulting even 1.00 point loss or win seems out of place. Some players might prefer that when two players have greatly different views of the odds that they should be playing a long shot bet rather than a bet that is close to even. As a related matter, when players have different views of the odds then the bet becomes more attractive. They are, therefore, more likely to want to increase their wager as they can do through the A-scaling that is described herein.

Odds Attractiveness Scaling (A-Scaling)

For perspective, first consider some fundamental aspects of wagering. Probabilities become apparent through frequent, repetitive wagering which enables calculation of averages and other central tendencies. A bettor can get lucky on any one bet, but probability assessment and gambling skills are more accurately ascertained over the course of multiple bets.

As long as they are not based purely on luck, most forms of wagering, in varying degrees of effectiveness, can provide indications of a player's ability to gamble. In one way or another, gambling skill is commonly and largely determined by probability assessment, even if players are not overtly setting odds. And, percentage odds setting, in turn, is arguably the most systematic, formal, precise means to assess risk and determining knowledge of bet-suitable subjects. Traditional wagering often does not require players to set odds. Often, players are merely picking positions on an outcome with a known payout. Compared to odds setting, traditional wagering decisions, such as deciding a position, or how much to bet or raise are not as effective a means of assessing knowledge and gambling skill. In many ways, the methods described herein enable players to establish their gambling skill, odd setting prowess and expertise on matters in a more accurate, quick, clear manner. An important means of doing so is the subsequently described odds attractiveness scaling (or A-scaling).

Another relevant firmament aspect of wagering is that the amount a bettor wants to wager tends to relate to how attractive the bettor perceives the bet. This is not a proportional, consistent, correlation since other factors, such as financial resources and risk tolerance, influence how much a player wants to wager. However, in general, when a player likes his or her chances they want to bet a larger amount then when they see their chances as just fair or less than fair.

As described in the section on embodiment D, an IOA's proximity to the FOA is referred to as the IOAP. As described in embodiment B, an opposing player's IOA can serve as the FOA for one of the bets on a bet statement in a two-player game. In a two-player version of embodiment B, the IOAP is the difference between the two IOA's. Since the IOAP of each player in such a two-player game always equals the IOAP of their opponent, the term IOAP, in this instance, is used to mean a singular positive one or two digit whole number that is the same (or in other words, “shared”) for both players. For example, if one player sets the odds at 18% and their opponent sets the odds at 34% then the IOAP is 16.

Two-player embodiment B illustrates how this IOAP can effectively measure how attractive the two players find a jointly entered wager relative to their odds (or risk assessment). Recall that embodiment B ensures both players their preferred side of a wager according to their odds. The wager is really two similar wagers on one bet statement where each player's odds are used for one of the bets.

Because the players get to bet on their preferred side of their opponent's odds, as the size of IOAP (the gap between the odds) increases, the two players will both find the bet more attractive (at least, according to their odds assessments). Consequently, on that basis at least, both players are more likely to want to increase the bet. Odds attractiveness scaling automatically and proportionally increases a wager depending on how players view the attractiveness of the wager as defined by their relative IOA's.

Before describing the various ways odds attractiveness scaling (or A-scaling) can be done, it is helpful to define the objectives of A-scaling. There are three primary benefits of attractiveness scaling that could also be viewed as benefits to a player.

First, as an automated customizable process it is a convenient way for the players to increase their wager amount when they believe (according to their relative odds) that it is appropriate and advantageous to do so. A second benefit is that increases are calculated and performed in a measured, consistent, and logical manner. The third benefit of A-scaling is to create a contest that more distinctly and effectively demonstrates probability assessment, and expertise in subject matter and wagering. Such a game puts a premium on skill rather than luck and is more dynamic and challenging and has more potential for success.

It often takes a series of bets to prove gambling skills. Winning a single bet might make it a little more statistically likely that a player has superior gambling skill, but it does not prove superior expertise because a player can make a foolish bet and still get a lucky win. Still, people tend to feel winning a bet does prove a point, and that is especially true when there is a large difference in IOA's, and, therefore, a large IOAP.

Even without A-scaling, a large IOAP is more exciting than a tiny IOAP. This is not just because a large IOAP means a more attractive or bigger bet, but because it reflects a larger, fundamental difference of opinion. Furthermore; winning an embodiment B bet with a very large IOAP is far more statistically relevant in terms of proving the likelihood of superior odds setting expertise, than winning a bet with a tiny IOAP of one or two percent.

The excitement and enjoyment is, arguably, greater when players know they are using attractiveness scaling, which can potentially raise the stakes when players have not wisely assessed the odds. Even for a smart, confident player it is human nature to question one's self (or one's own IOA) when you discover your opponent has a radically different IOA or prediction.

This makes sense because an IOAP of just 1.0 means players have very similar assessments yet they still can be placed on completely different sides of a long shot bet. (For these reasons, one interesting variation of the embodiments is to automatically cancel all bets that don't meet a minimum requirement for IOAP size.)

When A-scaling is used, an already highly indicative large IOAP bet takes on even greater importance. In effect, odds attractiveness scaling systematically increases wagers as odds diverge, which exaggerates the importance of opinion.

Before describing A-scaling further, an explanation of the A-scale multiplier is given here. A formula or number, called the A-scale multiplier, is preferably designated by the players, but could be deprived from game statistics. A mathematical formula or calculation, preferably multiplication, is used in conjunction with the IOAP and the A-scale multiplier to calculate the A-scaling amounts either indirectly or directly. In one embodiment the A-scale multiplier is multiplied by IOAP. By multiplying with the A-scale multiplier, rather than doing an inferior alternative calculation, such as adding, the amounts retain their fair proportionality according to the placed bet odds and bet(s). So, for example, the A-scale multiplier might be set between 0 and 30 to dictate the impact of A-Scaling.

Here is a preferred embodiment example of A-scaling that uses an embodiment J version of embodiment B. In other words, two players each submit an IOA, and a single bet is arranged using the middle odds average (MOA) so that each player gets their preferred position and terms that are more than fair according to their own IOA. (The one exception, as described elsewhere, is that the bet is merely fair rather than more than fair if the IOA's are equal.) Part of this preferred embodiment example is to display and calculate A-scaling as a percent increase over what the payout projection would have been without A-scaling. A base display of 100% would indicate that no A-scaling occurred in the bet arrangement process. (No A-scaling would occur if the players submitted identical IOA's or if the option for A-scaling was not used.) So, for example, a 112% display would mean that the A-scale increase was 12%. In this embodiment of A-scaling the initial projected payouts would include any increase from A-scaling, and the A-scaling percent increase is determined by multiplying the A-scale multiplier (set by the players) and IOAP, and using the resulting product as a percentage amount. If, for example, the A-scale multiplier was set at 7, then the bet amount would increase the bet 7% for every percentage point between the two IOA's.

To illustrate, the bet statement is that “The Packers get a first down before the Bears.” Player A enters an individual odds assessment (IOA)™ of 64% and Player B enters 70%. The middle odds assessment (MOA) of 67% is used as the bet odds. Players are placed in the bet position they prefer relative to their IOA's: Player A wins on a negative outcome and Player B wins on a positive outcome. Without A-scaling, and using the Ultralow risk scaling™ option described in the parent application, B wins 0.33 points if the outcome is positive, and A wins 0.67 points if the outcome is negative. However, if A-scaling was used and the A-scale multiplier was set at 7, then the payout projections would be increased 42%. (The IOAP is 6 which is obtained by subtracting the 64% IOA from the 70% percent IOA and using the result as a whole number. Multiplying the A-scale multiplier of 7 by the IOAP of 6 equals 42. This result would be used as a percent and added to the base amount of 100%. So the A-scale display would show 142% and the bet would be automatically increased by 42% over what it would have been if A-scaling was not used. Therefore, B would win 0.47 points (not 0.33 points) if the outcome is positive, and A would win 0.95 (not 0.67) if the outcome is negative.

When A-scaling is used the preference is to just display the initial wager points before A-scaling and then the wager points after scaling. Yet displaying IOAP can help players follow what and how scoring occurs so an alternative is to display IOAP, but doing so is not essential.

In a two-player embodiment B, IOAP is an effective, accurate measurement of a bet's attractiveness to both players in part because each percentage or point is an exact interval of measurement that relates to (and is based upon) the complimentary odd setting and scoring system described herein.

Illustrated here using two-player embodiment B, A-scaling is preferably done by multiplying the initial wager points (or possible win and loss projections) by an A-scale multiplier. Preferably, A-scaling occurs after any R-scaling of the initial points, but A-scaling could be done before R-scaling of the initial points, or otherwise. A-scaling is preferably a selected pre-game option rather than a default setting of the game.

Assume that the bet statement is “Our friend Xavier will arrive here by the agreed meeting time of 8 p.m.” Through a pre-game agreement the players agreed to use the A-scaling option. Yolanda's IOA is 15% and Zoie's IOA is 30%. Therefore, Zoie wins the bet (or, in a sense, wins two bets) on a positive outcome. The initial wagering payout points on a positive outcome is 0.85 for the bet on Yolanda's odds and 0.70 for the bet on Zoie's odds for a total of 1.55. So in a positive outcome, Zoie's score (or account) would increase 1.55 while Yolanda's score decreases 1.55. The pay out on a negative outcome is 0.15 for the bet on Yolanda's odds and 0.30 for the bet on Zoie's odds for a total of 0.45

A formula or number, called the A-scale multiplier, is preferably designated by the players, but could be derived from game statistics. A mathematical formula or calculation, preferably multiplication, is used in conjunction with the IOAP and the A-scale multiplier to calculate the A-scaling either indirectly or directly. Preferably, the A-scale multiplier is multiplied by the IOAP. In this manner, the bet amounts retain their fair proportionality according to the placed odds and bet(s).

Assume the A-scale multiplier is customized to be 2.00. Since IOAP is preferably expressed as a whole number, the resulting product is divided by 100 and then added to 1.00. In this case, 2 multiplied by IOAP of 15 (from the illustration) equals 30. When thirty is divided by 100 and then added to 1.00 the total is 1.30.

The 1.30 A-scale bonus is based on an IOAP of 15 and represents a 30% increase in the size of the bet. So, as an aside, if there is an IOAP of 50, then a A-scale multiplier of 2.00 doubles the bet. The A-scale multiplier can be set by the players. Preferably, A-scaling replaces any stage and option of manual doubling or bet increasing that occur as a default or at the discretion of players. When multiplied by the 1.30 A-scale bonus, the 1.55 points won or lost on a positive outcome become 2.015, which is rounded to 2.02. Multiplying 1.30 with 0.45 produces the won or loss points on a negative outcome of 0.585, which is rounded to 0.59.

In a three-player embodiment G, there are multiple IOAP's but that is not a hindrance because A-scaling is applied separately to each of the sub-bets. Each player is in four bets on one bet statement. After A-scaling is applied to the sub-bets the outcome scores of the sub-bets are calculated then the sub-bets are added together to determine the final score. (This simple illustration is ignoring for now the issue of R-scaling, which is discussed herein, and it is assuming that bet and game loss caps are not in use.)

The above illustrations show how A-scaling functions in zero-sum scoring where one player's loss is always another player's gain, but A-scaling can also be applied to scoring that doesn't perfectly transfer points from one player to another.

A-scaling increases the wager proportionally as IOAP increases to meet the needs of the players and make a more skill-based dynamic game. A-scaling can be based on IOAP or a formula that factors in IOAP and other criteria Similarly, the A-scale multiplier could be applied in ways other then simple multiplication.

In summary, A-scaling automatically raises a bet according to the mutual attractiveness of the odds as proportionally measured by the distance between the two player's IOA's. This individual odds assessment proximity (IOAP) measures the divergence in opinions. Since each player gets their preferred side of the bet, both players perceive the bet as increasingly attractive in direct proportion to increases in the gap between IOA's. A-scaling is logical since attractiveness tends to determine how much is bet. Streamlining mandated fair raises demonstrates subject matter expertise more effectively than traditional wagering where an opponent's assessment of the odds can be learned before the bet is made. Discovering A-scaling results is one of unique, extra thrill.

Coordinating A-scaling, R-scaling, Loss Caps, and Manual Increases and Descreases

A-scaling, R-scaling, and loss caps and manual raises or decrease do not have to be used or allowed, but may be used or allowed together, and may be used in different orders and combinations.

The embodiments described herein may automatically or manually decrease bet payouts to fit under pre-set loss caps. Loss caps may block game actions and prompt error/alert messages when a payout projection exceeds the maximum loss allowed in a game or an individual bet. Exceeding loss caps may also trigger an automatic reduction of payout amounts so that they fall just within the loss caps.

Preferably, R-scaling is used to provide the initial bet payouts, and R-scaling is calculated before any A-scaling calculation occurs. Preferably, payout projections are checked against loss caps as a subsequent step so that the loss caps can safeguard against bet amounts (payouts) that are larger than players want to risk. Preferably, manual increases or decreases of payouts by the players occurs after any R-scaling or A-scaling and after the loss caps have been checked and after projected payouts have been displayed. Preferably, loss caps can modify and limit the initial payout and can also be checked again when manual increases are attempted and block manual increases that exceed the loss cap.

Decreases to bet payouts that are triggered by a loss cap may occur if the length of the odds and any A-scaling increase create potential payouts that violate a bet or game loss cap. Payouts may be decreased to just fit into the cap's maximum amount allowed. Payout decreases prompted by a game loss cap should be uncommon and only happen toward the end of the game.

The scaling or payout decreases prompted by loss cap settings occur before the bet begins so that an unacceptable risk is caught and canceled or modified before the player has to assume responsibility for it.

Sophisticated platforms and systems with large display screens make it more feasible to break out the evolution of projected and actual wager points during the bet process so that players can see and have a better understanding of how scaling and other aspects of the process effect the wagering amounts. Understanding the impact of different parts of the process might help players fine tune customized settings to meet their needs. Players may be given a choice about using either, both, or, in a sense, neither A-scaling or R-scaling. As previously described, R-scaling and A-scaling preferably maintain the proportionality of win and loss payouts that is first established by FOA or the odds assessments of one or more players. However, the scaling methods could be done in disproportional manner. A disproportional manner might suit embodiment H which does not use trade-off scoring where one player's win is always another player's loss.

Embodiments that Add Other Incentives

The methods described herein may include additional incentives. Incentives subtly redefine the goals or scoring and related rules of the game. The preferred way to meaningfully enhance embodiments of the present methods using incentives, such as point rewards, is to tie the incentives to the relationship between IOA and FOA, MOA or another IOA.

As previously described, IOA's proximity to FOA (which can be an opponent's IOA) is referred to as IOAP. Embodiment D rewards players for obtaining a low IOAP by improving chances for improving the player's odds. An alternative method of rewarding a low IOAP is to deduct predetermined points from a player's score for every percentage point in their IOAP. Low IOAP could even be rewarded by giving players greater choice in their bet position. The subsequently described embodiment N uses an inverse, proportional scaling system to reward proximity to FOA.

Punishment is an alternative to reward and whatever is used as a basis for incentives or bonus reward points can also be used for punishment in which points are deducted. Avoiding punishment in the form of penalties is a type of reward

Depending on what embodiment is being played and whether an IOAP related incentive reward is used a player may choose to set their IOA based on their perception of the real odds or based on what they suspect the FOA will be. The need for players, therefore, to understand FOA and IOAP determination means that it is preferable to make FOA a simple calculation such as the group-averaged odds (GAO).

Various types of team competition are possible. The preferred means of team competition is to have players competing as usual, as an individual, but to assign individuals to teams, and then add or otherwise combine the scores of the players who are competing separately as individuals. Once the individual scores of the players on a team are combined they are compared to the combined individual scores of players on another team and the team with the higher scores wins.

The subsequently described embodiment E enables competition between bettors playing dissimilar series of bets by comparing players on the basis of average score per bet. Similarly, teams and the individuals in a teams can be dissimilar in terms of number of players, or bets played and still compete on the basis of average score per bet.

Embodiments Used by a Real Gambling House

Typically, gambling houses set unfair odds that favor the house (i.e., unfair odds). A gambling house using one of the described embodiments may allow players to set their own odds and get a fair (according to the player's odds estimate) wager without the house building in a cut for itself. In such an instance, a house's gross profit is obtained by the profit that occurs when a player estimates the odds poorly and the house then gets to choose the attractive side of the lopsided, unfair bet. When players pick the odds very accurately the house makes little profit or just breaks even on those bets.

If the player sets odds that are identical to the odds that a gambling operation is using to pick its positions then the house might still have a profitable or hedging advantage because it can still pick its position on the bet. A computerized system can be set to automatically, until further notice, choose one side of a bet when FOA equals IOA. A manually set flag or other criteria set can be used to decide which side of a bet is selected in such instances.

A gambling house that applies this method never has to reveal the odds it sets on a bet because they are only used for the house's own decision making purposes regarding which side of the bet the house takes. Moreover, the house can be constantly and automatically changing its FOA (which is the setting that determines its choice of bet position) manually or automatically based on the opinion of its administrators or based on FOA group analysis calculations. The section on embodiment A explains how a “moving” FOA can be calculated based on early IOA submissions.

The present method gives the house another unique advantage because it forces the bettors to reveal their odds estimates which are a more telling indicator of individual opinion (and collectively, group opinion) then merely having the bettors pick a position. When a single bettor picks a bet position, the selection does not tell the house whether the player thinks the house is giving great or just average odds. A house can sometimes have trouble assessing odds and therefore needs to consider the collective wisdom of the bettors as expressed by their bets and react accordingly.

Through experimentation or collusion savvy players might get a very good idea of where the gambling operation places the odds and thereby decrease the chances of setting odds that house would prefer. Still, the advantage gained by player's occasionally setting odds away from the gambling operation's odds might well cover operational cost and leave an attractive net profit If a house wants still more of an advantage in obtaining profits it can use in conjunction with the present method a variety of incentives, limitations, or user fees as subsequently described.

Incentive or Profitable Design Modifications Used by a Real Money Gambling House

A gambling house offering real money wagers may make design modifications that increase interest in the game or that improve the house's margin or ability to profit per dollar wagered.

As described, from a bettor's perspective, the present method has significant advantageous over the traditional wagering systems. Yet most bettors know that in return for what they see as fair odds they are giving the house the advantage of choosing the position, and therefore may still be reluctant to bet.

Preferably the house structures the embodiment so that the bettor is locked into the bet (based on his own odds) and the agreed bet amount before the bettor learns which position they are assigned. An alternative that could be viewed as an incentive is to let players learn which position they are forced into and then still back out of the bet if they don't like the position with out losing any or much of the agreed stake.

If a house is convinced it can still remain profitable, it may try to stimulate business by improving the offer with an inducement. For example, the house could guarantee a more than fair bet according to a bettor's odds by always adding 1% or 0.01 initial base points of the wager amount (as described in the parent application) to the side of the bet assigned to the bettor. If a bettor sets odds at 70% and the house picks the 70%-chance positive outcome side of the bet, than the odds (which are the basis for determining the wager amount) and, thus the base wager points, are recalculated to 71%. Therefore, on a positive outcome the house wins only 0.29 (not 0.3) and on a negative outcome the house loses 0.71 (not just 0.7). This of course means that if the player sets odds that are identical to the houses FOA that the house would on occasion be forced into a slightly bad bet.

Adding on 1% for the bettor to sweeten the offer means that the sweetener grows in proportion to the wagered amount. Capping the total amount of money that the sweetener can add or creating a flat deal sweetener that doesn't grow with the size of the bet can limit a house's risk but still let the house state that it offers “more than fair” wagers.

A house may find it harder to make an attractive profit with such a system, especially if too many players work together to identify the house's current FOA. The solution is to clause the offer for “more than fair wagers” so that the house reserves the right to decline the wager, which it can do when the odds are too close to FOA.

The house must tell the player which side of the bet they are on but preferably doesn't tell a bettor the FOA they are using to choose a position. A single bettor or a group of colluding bettors could place (or in other words be assigned a position) in a few tiny bets. The placements would enable them to zero in on where the house is setting the FOA. However, a house can be constantly adjusting and changing the FOA.

A house could acquire revenue by a membership system or by fee systems that calculates fees per bet, game (bet series), play time period, or as a percent of total winnings. Or, a house could stimulate interest in playing by offering new players incentives such as a free account credit. Prizes or rewards could also be used and even calculated on statistics such as total number of bets made.

Players with a low IOAP or other successful accomplishment can also be rewarded for their success by receiving a privilege to double the points or otherwise raise the stakes. Once players have been placed in a position with set odds a gambling operation could give players the ability to proportionally raise the stakes. A gambling operation could do so at its own discretion and do so automatically depending on how much it liked the bet and how much a player had in an escrow account.

Now that several embodiments have been explained, it should be pointed out that hiding an IOA's from an opponent can be important in several embodiments. This is particularly an issue in embodiments that enable two player or small group competitions, where a non-networked computer running a game embodiment might be shared and players could just look over someone's shoulder or on the screen and see an opponent enter their IOA. Hiding IOA's is less of an issue in networked embodiments where players are using separate client computers at separate locations. More specifically, in a two player game, it is important for the first IOA that is submitted to be concealed from the player that enters their IOA last. If the player that enters their IOA last knows the IOA of the player or players that entered their IOA's earlier, than that last player to enter the IOA could use that knowledge to gain an advantage. If the IOA entered first is known than the player entering their IOA last can guarantee and in effect choose their position in the bet by selecting an IOA just higher or lower than the IOA entered first. So embodiments may contain options, play sequences, graphic interfaces or security precautions that enable players to conceal their IOA from their opponents. In some embodiments, it won't be important for the final player that enters their IOA to conceal their IOA because the opponents would not be able to change their IOA.

Embodiment J and MOA

The middle odds assessment (MOA) is the middle difference between an IOA and the related, determined FOA, which can be an opponent's IOA. In contrast, the group averaged odds (GAO) is average size of all IOA's (or qualified IOA's) for a bet statement.

Embodiment J is similar to embodiment A, but after the FOA is determined, the system adds the FOA and a player's IOA together and divides by two to find the middle odds assessment (referred to as MOA) between the FOA and the IOA. Instead of being forced into the “unpopular” position of a bet using the IOA as the odds, as occurs in embodiment A, embodiment J forces the player into the “unpopular” position (according to FOA) of a bet using MOA as the odds.

Embodiment J could as an alternative use a formula to establish the odds that are used to bet on at any positions between the IOA and the FOA of a bet statement. For example, the odds used to bet on could be set at 75% of the way toward the FOA instead of at the halfway point of MOA. In that case, if the IOA was 70% and the FOA was 78%, then the bet odds would be 76%. In addition, the odds used to bet on could be set on or between IOA and FOA in an inconsistent or random manner.

Embodiment J does not reveal (via a player's performance) who is a good or bad player as quickly as embodiment A does, but it, on average, improve a player's winning percentage. (Embodiment A can be disheartening because players often end up with a negative score since they are continually forced to play against conventional wisdom.) Embodiment J also enables promotion that players can make bets that are more than fair (according to their assessment) almost all the time.

An alternative for embodiment J is to apply the asynchronous embodiment E rather than the more concurrent embodiment A. This alternative is played like embodiment E, but the player's bets are again made using MOA rather than IOA as the odds, which improves the player's chances of winning a bet

Even if a player thinks that the FOA or the MOA are far less accurate predictions than their IOA, the player still benefits from making the bet using MOA rather than IOA. A player can win more and lose less when a bet is made with MOA rather than IOA.

Alternative versions of embodiment B or embodiment I or other embodiments could use the two IOA's to calculate MOA, and display it to the players and use MOA as the odds for just one bet on the one bet statement. The relative position and comparison of the two IOA of the two players making the bet would still automatically determine their positions just as in other embodiments. The difference is there is only one bet that uses the MOA as the odds rather than two bets where one of the bets uses one players odds and the other bet uses the other player's odds.

This alternative method of using MOA for the odds also applies to embodiment G. For example, in a three player game, each player would be in two bets so that one of the bets is with each of the other two players. So, embodiment J's MOA system of determining just one bet works particularly well as a substitute for the two-or-more-bets-on-one-bet-statement system in embodiment B, embodiment K, etc.

Embodiment K

Embodiment K is similar to embodiment B. In a two player scenario, each player submits their odds, and position placement (i. e. preference) is still determined by the odds in relation to each other. However, unlike embodiment B, embodiment K doesn't have two bets on one bet statement (or use MOA as the odds for a single bet on a single bet statement as described in embodiment J).

Instead, embodiment K makes one bet on just one of the two IOA's based on a method or combination of factors that are pre-selected by the players. The term “picker” refers to the player that gets the privilege and advantage of being automatically placed in the position they prefer (according to their IOA) in a bet that uses their opponent's IOA, which is also relatively advantageous. The means of determining the picker should enable the system to do it automatically but it could be done in a manual manner such as by letting the players bid points to see who gets to be the picker.

The preferred means that the players can pre-select to determine the picker is turn-taking so that one opponent's IOA is always used on the even numbered bets while the other opponent's IOA is used on the odd numbered bets. Alternative picker determination options are to make the winner or the loser of the previous bet the picker. The player with the highest or lowest total point score in the game at the time of the bet could be determined the picker. If the losing player in the game or last bet is determined to be the next picker then that is an advantage to the weaker player and can function as a handicap. The player that is the picker in the first bet of the series may be determined by a random choice generating routine or on the basis of some game or player characteristic or status or a manual decision process such as a coin flip. If group average odds can be developed from other players playing the same bet in other games then proximity to FOA could be used to decide who gets to be the picker.

Embodiment K also works when there are more than two players. To illustrate, assume three players agree to use turn taking to determine the picker so they each in turn become the picker on one third of the bets. The players submit their IOA's (odds). The picker's IOA is in the middle or on one of the polar ends. The picker is placed in the picker's preferred position, according to the picker's IOA, in a bet against each opponent that uses the opponent's IOA for the odds. In a three player contest there would always be two bets. If the picker's odds are in the middle he is in a hedge situation where he is in opposite positions in the two bets. If the picker's odds are on the low or high end then the picker is in the same position on both of the bets.

Embodiment P describes a game that provides a reward to the player that has the middle odds, and that is put in a hedge situation. Embodiment K could also increase the scoring opportunity of the picker when the picker is in a hedge situation.

Embodiment K's determination of odds and positions by turn taking can also replace the type of IOAP and IOA based determinations of bet odds and position used that is used in embodiment C and P. Embodiment K's picker method also works when the MOA serves as the odds for a single bet on a single bet statement.

Here is a summary description of what a bet round would consist of using embodiment K and the Picker method in a two player design.
The bet statement is “Zarena will arrive here for our planned meeting at 8 p.m. according to the clock behind the bar.”
a Each player enters their IOA (odds assessment) in the handset.
Assume players use a preset option that automatically arranges play so that players take turns being the “Picker.” (Other options could be whoever is losing or winning at the start of the bet round or whoever won or lost the last bet is determined to be the Picker as described in embodiment L.)
The Picker's advantage is getting their preferred position (according to their IOA) in a bet using their opponent's IOA as the odds for the bet.
Xavier's IOA=12% and Yolanda's IOA=28%.
Assume Xavier is the Picker, Xavier's IOA is the lowest so he gets the no (negative) position.
Yolanda, who thinks a positive outcome is more likely, is in the yet (positive) position.
The position and initial win or loss point projections are displayed. Xavier pays Yolanda 0.72 if the outcome is positive and Yolanda pays Xavier 0.28 if the outcome is negative.
At this stage the bet is set, or rules could allow one or either players to raise (or increase the bet payouts).
The outcome is entered and bet round and updated game score are displayed and processed.
   Embodiment L

Embodiment L is very similar to the two-player method described above where the players are always on opposing sides of a wager. The difference is that instead of taking turns choosing positions, the player that won the last bet in the series always gets to pick the position in the next bet. The player that is the picker in the first bet of the series is preferably determined by a random choice generating routine or on the basis of some game or player characteristic or status.

Embodiment M

Embodiment M is similar to embodiment I, in which a celebrity can play a plurality of independent one-on-one games at the same time against a plurality of opponents. As previously referenced, embodiment I could apply the two-bets-on-one-bet-statement system of embodiment B, or the MOA system of embodiment J, or the Picker system of embodiment K or embodiment G and other embodiments of this present method.

Embodiment M describes another means of determining bets that is well suited for embodiment I, but could also be used in other two-player embodiments where FOAs are being determined or easily could be determined for the bets in the game. In this embodiment M, it is preferable that the FOA be largely determined by the collected qualified IOA's. The embodiment I that facilitates celebrity participation is preferably played via the Internet and tends to generate many IOA's on any bet statement so an appropriate FOA can be easily calculated from the IOA submissions.

The two players competing in embodiment M both submit IOA's for a bet statement, and whichever player's IOA is closest to the FOA is determined to be the picker, as described in embodiment K, that enjoys their preferred position on the opponent's IOA. According to the playet's perceptions, as expressed in his or her IOA, the player prefers to use the opponent's IOA as the odds rather than his or her own IOA (as long as the player is in the preferred side of the bet) or the FOA. So picker's submitted IOA (relative to the opponent's IOA) is what determines which position the picker gets on a bet on the opponent's IOA and the opponent is, of course, placed on the other side of the bet.

Embodiment N and B-Scaling

Embodiment N is styled after embodiment A but it increases the winning percentage of the players even more than Embodiment J (This assertion assumes that the collective wisdom of players as expressed by a FOA is, on average, more reflective of the real odds or risk.)

Embodiment N places a player in the player's preferred side of a bet (according to their IOA) that uses FOA as the odds for the bet. However, Embodiment N needs to be modified to keep players compelled to set IOA in good-faith so that IOA represents a player's true or near-true belief in the odds. If IOA only determined a player's position on a bet using FOA as the odds then the player has very limited concern about the accuracy of their IOA. For example, if the player can reasonable predict that the FOA is going to be in a broad range of between 55% and 85% then they could set their IOA (odds) at 40% or 1% and be confident that they would still be placed in the negative position of the bet that uses the likely fair FOA as the odds that are bet upon.

Even though FOA (rather IOA's) is used as the odds for the bet, the player maintains some control, however slight, over the odds because FOA factors in the player's IOA (unless it doesn't qualify).

Embodiment N resolves this good-faith incentive dilemma by using B-scaling, which awards bonus points in proportion to the IOAP. The lower the IOAP, the more bonus points a player acquires. Bonus points are added on to a player's score, if he or she qualifies, regardless of whether the player wins or loses the bet.

Setting the IOA near the FOA is advantageous in some other embodiment because it reflects likelihood that the player gets to enter a more attractive wager, but that is a less direct reward. Embodiment N (and embodiment D) reward players for a low IOAP as opposed to some other embodiments that use IOAP to proportionally increase wagers according to the bet's level of mutual attractiveness as indicated by the size of the IOAP. Embodiment N rewards a low IOAP with bonus points which is a contrast to embodiment D which rewards the lower IOAP by enabling a player to play odds that are likely to be more advantageous.

Since embodiment N depends on the IOAP, it is preferable to determine the FOA on the basis of qualified IOA submissions rather than including in the determination other potential factors, such as an administrator's odds assessment. An FOA that is determined by player submitted IOA's gives bettors a clearer sense of what they are trying to assess or match.

The preferred method of proportionally awarding bonus points uses a bet's average IOAP (AIOAP). AIOAP is calculated by adding all the qualified IOAP's associated with one bet and then dividing the total by the number of qualified IOAP's that were added. AIOAP preferably uses normal rounding practices to round off to a one or two digit whole number.

Preferably, an IOA is qualified for the AIOAP calculation if it was included in the FOA determination. If the FOA determination was not largely based on GAO or other calculation that excludes anomalous IOA's, then the AIOAP determination process might include a calculation to exclude anomalous data. If a player's IOA is too anomalous to qualify in FOA or AIOAP calculations, they can still participate in the bet, but their chances for success are poor.

Embodiment N's inverse bonus point scale (referred to as B-scaling) proportionally increases points as IOAP decreases. B-scaling uses a customizable number called the bonus multiplier to let an administrator (or players) control the impact that bonus points have on scoring relative to the impact that the points from the bet outcomes have on scoring.

The bonus multiplier is a number or data that may be determined using different algorithms, or designations, or combinations of algorithms and designations. Designations or the bonus multiplier can be based on factors of the game or the assessments of the players, an administrative provider, house, machine or related factors outside the game.

A mathematical formula or calculation, preferably multiplication, is used to associate and reflect the AIOAP inversion number and bonus multiplier. Preferably, calculation of a player's bonus points is done as follows: First, a player's AIOAP inversion number is calculated by subtracting a player's IOAP from the AIOAP. For example, if the AIOAP is 8, then any player with an IOAP of 0 has an AIOAP inversion number of 8. If a player's IOAP is 1, then their AIOAP inversion number is 7, and so on. If a player's IOAP is 8 (which is the number of AIOAP), then their AIOAP inversion number is 0. A player may only get the full amount of available bonus points if their IOAP is 0. Bonus points are only earned if the AIOAP inversion number is positive.

Second, the system multiplies the player's AIOAP inversion number by the bonus multiplier and then divide the resulting product by 100 to obtain the player's bonus points.

AIOAP measures or reflects variability or the degree of difficulty the players have collectively had in estimating FOA (e.g., the average IOAP proximity to FOA). The higher the AIOAP, the higher the level of difficulty in predicting the FOA, and the higher the bonus points awarded. In preferred B-scaling, the higher the difficulty predicting FOA, the higher: (i) the likelihood that more people will qualify for bonus points; (ii) the greater the average bonus points awarded per qualified player; and/or (iii) the higher the top awards are.

For example, assume that there were 100 bettors in a competition and the AIOAP was calculated as 8. Also assume that: (i) 6 bettors had an IOAP of 0 (where the IOA equals FOA); (ii) 12 bettors had an IOAP of 1; (iii) 9 bettors had an IOAP of 2; (iv) 13 bettors had an IOAP of 3; (v) 7 bettors had an IOAP of 4; (vi) 6 bettors had an IOAP of 5; (vii) 9 bettors had an IOAP of 6; (viii) 0 bettors had an IOAP of 7; and (ix) 4 bettors had an IOAP of 8. Bettors who had an IOAP of 8 or more do not qualify for bonus points. To qualify for bonus points a bettor must have an IOAP that is less than the AIOAP. Therefore, the number or percent of players who qualify for bonus points is proportional to how difficult it was for the players to pick the odds.

Assume the bonus multiplier is set at 5.00. The player(s) with IOAP of 0 get bonus points determined by multiplying 5.00 with 8. The product of 40 is divided by 100 so the bonus points are 0.40. When the straight sliding amount of R-scaling is used and no ranking-weighting system is used in embodiment N (or A), the point scores range between 0.01 and 0.99. So in this example, the bonus points for the player(s) with best FOA prediction (or lowest IOAP) are roughly equivalent to the points won or lost are on a bet with near even odds. For the players with the IOAP of 1, the bonus point award is 0.35, which is calculated as follows: (5×7)/100.

Preferably, bonus points are added to points won or lost on the main bet. Alternatively, multiplication could be used rather than addition to combine the main bet points with the bonus points. Use of multiplication is best done by adding 1.0 to the bonus point total before multiplying it with the main bet points to determine just the bonus points or to determine the amount that includes both the bonus points and the main bet points. Alternatives could use a combination of multiplication and addition.

Preferably, embodiment N does not use trade off scoring where one player's gain is another player's (or the house's) loss. The scoring system maintains the proportionality of risk to reward that is established by the odds only until bonus points are added. When bonus points are added regardless of whether a player wins or loses the base bet, then the risk-reward proportionality is lost. The embodiment is still fair since all players face the same situation.

In an alternative means of calculating a player's AIOAP inversion number, the system first determines which non-negative integers from 0 to whatever number the AIOAP is contain or are equal to the IOAP of one or more players. Second, the system counts the number of IOAP-matching non-negative integers. Third, the system assigns a IOAP-matching level to each non-negative integer number that matches up with at least one player's IOAP so that IOAP-matching level one is the lowest matching non-negative integer, level two is the next lowest matching non-negative integer, and so on. Each level represents an IOAP number that matches at least one player's IOAP. Using this alternative means, the AIOAP inversion number for a specific player is calculated by subtracting the IOAP matching level (that is associated with the player) from the AIOAP. In this alternative, the player(s) with the lowest IOAP get the same bonus points regardless of what the IOAP is.

In another alternative example, the bonus multiplier could change size according to the size of IOAP or another game statistic instead of remaining fixed. The bonus multiplier could be linked to the bet outcome or even the setting for R-scaling. As another example, bonus points could just be added to the score of the player or players who wins the base bet.

Embodiment N involves two complimentary, and nearly simultaneous competitions. One is predicting FOA and other is the bet. Ironically, because FOA is determined only after the bettors submit their IOA's, the bettor that participates in embodiment N is placing a bet before the bettor even knows what the odds of the bet are or which side of the bet the bettor will be in. The way that embodiment N uses B-scaling to enable players to be placed in the attractive side of a bet using FOA as the odds can also be an alternative means for embodiments such as embodiment E.

Embodiment O

Embodiment O places a player on the attractive side of their own odds according to FOA. However, to make bad faith odds setting unrewarding, B-scaling (rather than the bet itself) is the primary means of winning points, rather than the secondary means. Otherwise players could intentionally set bad odds to benefit themselves. Embodiment O still provides the two-games-in-one appeal of embodiments that use B-scaling.

Embodiment P

A three-player bet illustrates embodiment P, which draws on embodiments C and K. Three players submit odds to the system, which preferably calculates GAO as the FOA. The player with the IOA nearest FOA (GAO) is referred to as the hustler. If two players are tied for closeness to the FOA (GAO), then, preferably, a random choice generating sub routine determines who is the hustler.

The hustler has odds that are in between the odds of the other players in many cases. The hustler enters a separate bet with each of the two opponents where the odds used in the bet are the opponent's IOA and the hustler is automatically placed in the more attractive side of the bets according to the FOA (or, alternatively, the hustler's IOA). So (on the positively worded bet statement) the hustler is automatically placed into a negative (i.e. no) position on the bet if the IOA of the opponent is more than the FOA or placed into a positive (i.e. yes) position on the bet if the IOA is less than the FOA.

In effect, the hustler gets placed in an advantageous hedge where he or she loses one bet but wins the other bet and can come out with a positive score in a substantial majority of the group wagers. While the hustler has good chances of a positive score, one of the other players will frequently win more because the hustler's typical win is small.

Preferably, embodiment N requires the two other players to each have an automatic side bet with the hustler. If the hustler's total net score from the two main bets is positive the other two players each lose an amount equal to the hustler's point winnings on the main bets. If the hustler loses points on the main bets then the hustler must pay off the total net loss amount to each of the other two players to settle the additional side bets. The transfer of points on the hustler's advantageous side bets happens automatically. The hustler side bets are a default part of the game. A selection option enables players to not play side bets. The hustler side bets means the hustler can be the big winner rather than the small winner in the bet and, in effect, increases the reward for the player who is best able to predict FOA. More than one player may be designated as the hustler.

Embodiments Using Other Odds Formats and Upfront Stakes

Traditional X-Y ratio odds format and point spreads are common but also limited and confusing. For example use of points spreads can only, for the most part, be used to bet on the outcome of games in sports such as basketball or football. It's not practical for betting on a low scoring sport like soccer or for betting on the myriad of different bet-suitable events that comprise a football game. The limitations can best be seen in how uncommon and difficult it is to express a precise, unusual probability estimate such as 29% using a point spread format or X-Y ratio format.

A person of ordinary skill in the art could readily tell that the present method could be altered to perform wagering using an X-Y ratio odds format or though a point spread wagering system. Formulas for converting percentages to ratios and ratios to percentages are well known so the present method could allow players to submit odds as a ratio and then convert them to a percentage format to give players more flexibility in how they submit odds.

The present method enables players to set criteria for how much they will bet before and during a game and uses a point system to represent make-believe or real money. A person of ordinary skill in the art could readily tell that the present method, which includes forcing players into bet positions based in part on their IOA's, could be altered to perform the common form of wagering where players choose a money or point amount for each bet by manually entering it for each bet or by setting an amount in advance of all bets and then determining the pay off amounts based on this stake.

Concurrent, Discontinuous, Asynchronous, Dissimilar Variation

The present method is effective in both situations of sequential and concurrent play, continuous and discontinuous play, and synchronous and asynchronous play.

In the sequential format, a single bet is made and completed before another bet, the next bet in the series, is made. A bet is considered complete when the bet scores are calculated and agreed upon. A tentative series of bet statements can be planned in advance, but the sequential format means that the beginning and ending of the time period of the bet do not overlap. In contrast, the concurrent format allows for a plurality of bets to overlap in time.

Continuous play refers to a game which is, in general, not interrupted and delayed. For example, players may be making bets on different plays in a football game, but become distracted in the middle of the game by a long telephone call or become so preoccupied by the game itself that they stop placing bets for a half hour. A discontinuous game can be easily saved and put away on an impromptu basis and then easily turned on and continued later.

A synchronous format refers to games with relatively strict timetables, and process due dates, and games that have a more consistent, steady process and frequent interaction. In contrast, the present methods asynchronous formats give players more flexibility in terms of when they participate, how frequently they participate, and even what embodiments and bet content they use as the basis for their participation in a contest.

Embodiment E

Embodiment E is a dissimilar format that enables competition even though people wager on completely different subjects. In contrast to embodiment A, embodiment E does not require a player to be in the same series of bets that all the other competitors are in. Preferably Embodiment E is for: (i) a contest that occurs over a long period, such as four months; (ii) make-believe wagering for points that awards prizes to the best players. (However, real wagering using the embodiment and pre-arranged escrow accounts is certainly possible.) Two people that are among a large field of players could simply make informal side bets based on who achieves the higher game score; and/or (iii) participation by thousands of players. (However, it could be played by a small group.)

Preferably, embodiment E occurs as follows: First, there is an enrollment process where players agree to detailed rules. Second, players select diverse bet statements of interest to them to bet on from a large database that is regularly being updated and edited. Bet statements or opportunities can also be delivered (“pushed”) to players (via means such as e-mail or smart phone messaging), or broadcasted, or announced and distributed through hard copy publications. Players can propose bet statements, which a game administrator can post if they meet certain criteria, such as having quick and easily determined outcomes.

Bet statement invitation delivery services can be customized based on player profiles developed through the enrollment process, or by other means. Customized push marketing can be triggered by customer actions. For example, when an interactive television customer watches a show, a related bet offering may be provided. A second illustration is to send a player a bet invitation through their mobile smart phone that is relevant to their location, and activities within the location.

A cookie on a player's computer could be used to alert authorized participating partners that a player is accessing their site so that they can push customized, timely bet statements to the player. Participating partners are companies that might have product placement and promotional agreements with a game administering company.

The elements of each bet statement record include a bet statement and possibly an odds submission due date and a status indicator that can be set to open, closed, or completed. ‘Open’ means that players can still submit odds on the bet, which, in effect, means they are attempting to place a bet. ‘Closed’ means that a player can no longer attempt to place a bet because it has already begun. ‘Completed’ means the bet's outcome is determined (and results may be posted or individual accounts are updated).

Third, players begin to set and submit their odds (which in a sense represent what is to become bets) to the system. The odds for a positive outcome are preferably submitted as a one or two digit whole number. The long duration of games enables more diversity in bet statements and gives players greater flexibility over when they select and submit their bets. Odds setting can take little time but happen in a sporadic periodic manner over several months. A player could place odds on many bet statements at the beginning of the contest or place bets one or few at a time in an impulsive, sporadic, random fashion that naturally fits into their lifestyle. Therefore this stage can overlap with other stages of the embodiment.

Embodiment E has some of the same elements as embodiment A, such as placing odds on all bets and submitting just odds. However, not having to submit a strictly defined set of odds (bets) by one shared due date makes embodiment E quite different. A player may have bets of short or long duration. As outcomes are determined by the game administrator, the system will automatically update each player's betting records, which include statistics such as total wins and losses.

Since each player is betting on a unique series of wagers, the winners and order of finish is determined by a Dissimilar Comparison Score (DCS) and calculation. DCS is the average net score per wager, but it could also factor and reward player performance indicators such as the previously defined IOAP. Alternatively, players could be given bonus points or some incentive for submitting bet statement ideas or for the volume of bets placed or their winning percentage for bets. The player with the highest DCS wins and the order of finish is determined by comparing each player's DCS. To be declared a winner a player must meet criteria, such as a minimum number of completed bets.

Preferably, Embodiment E does not use any ranking-weighting system. (as described in embodiment A) and players have no opportunity to double or increase their bet beyond the initial base points. Preferably, the scoring system does not proportionally scale down the initial base points (or wager amount) as the length of the odds increases. (Such scaling that creates a sort of loss control is unnecessary when players are competing for prizes and their score does not translate proportionally into a win or loss amount.)

Preferably, when the odds and position are identical, the bet amount (preferably make-believe points) wagered is always predefined and the same for every player on every wager. In other words, regardless of the bet statement, the potential winnings and loss are always the same for any odds and position combination, such as the ‘Yes’ position on 30% odds.

What is commonly done in the few wagering formats that exist is to just give players bet statements with or without odds or a point spread already assigned to the bet statement. The players then choose a position (or winner), which can be done even when no odds or point spread is assigned. The present method preferably differs at this stage from what is normally done in that it does not provide odds. It requires each player to set odds, but does not require the player to choose a position on each bet.

In stage four, the FOA for each bet statement is then calculated based on the player submissions or other pre-determined criteria. This stage will usually overlap with the odds setting stage. Use of a “moving” FOA's as described in the section on Embodiment A may be useful in embodiment B, but the preferred format is to still calculate the FOA only once.

Embodiment A can depend on having a big enough group of players associated with every bet to do a meaningful FOA calculation. However, Embodiment E lets a player decide which bet to do. Therefore, embodiment E may have only one or two players betting on a statement. The FOA method for embodiment E therefore requires more flexibility or a different calculation process depending on how many players make the bet. In a situation where only one player has placed odds on a bet the preferred manner for determining the players position is to use a random number generator to assign the position. An alternative method is let the game administrator assign the position or to reject the bet.

Stage five is similar to what occurs in embodiment A. The player's submitted odds are used as just the odds for that one player's bet, and then the IOA comparison to FOA determines the player's position.

Stage six is to attempt to communicate to each player what bet positions the player has been forced into. This could be done for example, by sending the player an e-mail or by notifying them during the rules stage that they are required to access such information on a web site after a specific time.

In stage seven, outcomes are determined per the rules and entered into the system and the player's scores are then totaled. Total scores of the players are then compared to determine the order of finish in the contest Preferably, players are required to access such scoring information through means such as a web site, but alternatively, scoring information could be “pushed” back to the player for an additional fee.

Hybrid Embodiments

Some of the embodiments are hybrids of other embodiments of the method. The embodiments have interchangeable parts that can be modified slightly to produce a competition with intriguing and novel dynamics, but that still applies the methodology and keeps to the scope and spirit of the explicitly disclosed embodiments.

For, example, embodiment P is similar to embodiment C but it uses aspects of embodiment K. If it is played or formatted for a concurrent series of bets (rather than sequential bets), embodiment P could be played in the dissimilar, asynchronous way of embodiment E. Almost all the embodiments are suitable for competing within both the sequential series of bets or for concurrent overlapping bets. The process for a concurrent bets series is usually different from the sequential process because in the concurrent format you typically do the same stage, such as odds setting, for many bets before moving on to the next stage.

Use of Celebrities

The concept of a celebrity concurrently playing a plurality of independent games against different opponents is defined in embodiment I in a format similar to embodiment B, but the concept can certainly be applied to other embodiments, such M or C. Indeed, the embodiment P, which uses the hustler designation, might be particularly amusing for one regular player competing against two celebrities.

Discouraging Bad Faith Play and Cheating

A key determinant of any games success is that game design and scoring incentives discourage or make it difficult for a player to intentionally (or even by accident) detract from group games by cheating. A player can cheat for self interest or by intentionally acting disruptive or in a self destructive manner to annoy other players or to favor one player over another.

Some embodiments of the present application enable players to set their own odds and play their own odds, and to significant extent, even influence which side of the bet they are on. Players that do not set the odds accurately become vulnerable to their opponent's actions, and low scores, and they are often quite easy to spot and separate from the wagering activities.

Having the FOA calculation exclude anomalous IOA submissions from the FOA calculation also plays a role in preventing intentionally destructive behavior by players, because it prevents them from intentionally and significantly distorting FOA. Players are informed of the practice of excluding extreme IOA submissions to discourage attempting such destructive behavior and to enable them to make IOA submissions with confidence in the system.

Some embodiments are designed for play between a small number of players and these are best suited for face-to-face play between friends. The social relationships between players and the code of conduct rules and conflict resolution system also help to curb cheating, questionable gamesmanship, and bad behavior. The gaming administrator, preferably never controls real money of the players or takes responsibility for real wagering unless the method is used for real wagering against a real gambling house.

Embodiment Alpha: Odds Opinion Research, Polling and Reporting Methods

The embodiments described thus far, which enable competition among a large group of people, generate valuable, interesting statistical information. Therefore, an inherent byproduct of the methods herein described is statistical information and surveying, research, and statistical analysis methods, which are presented here as embodiments, Alpha.

In traditional wagering, odds or a point spread are usually given. However, sometimes no odds are even given, and the bettor decides on an amount to bet and a true or false position on an outcome occurring. Polls often involve strict yes or no votes, but many also use a continuum or scale system that enables respondents to indicate opinions or assess views to varying degrees between the extreme polar end of a continuum, such as ‘yes’ and ‘no’.

Offering participants inducements for participating in a research survey is common. However, methods of measuring and assessing good-faith, honest responses and participation in a survey and proportionally tying inducements to the assessment of good-faith participation are extremely uncommon.

The intent and value of the research byproduct is to gauge public opinion on popular issues in a timely, inexpensive manner. The entertaining statistics that are generated require only reasonable accuracy, rather than near-perfect scientific accuracy. Group opinion data obtained though the disclosed method can be analyzed and presented in many ways but it preferably shows the central tendencies rather than the entire distribution. The news worthy central tendency statistical content generated through the embodiments is syndicated or otherwise released to media at roughly the same time it is made available to the players as part of their participation in the competition.

Research embodiment Alpha may function as a survey to gain information and opinions from a participant and/also function as a test of a participant's risk assessment ability and knowledge of the subject matter. The method can then compare the abilities of the participants Alpha may be similar to the wagering embodiments that are well suited to large group competitions that are described herein. The survey or polling questions, like bet statements, are stated as a positive when possible. Participant submits an odds assessment as a one or two digit whole number. The main difference between the survey process and the large group wagering games is that the participant(s) is not placed in wagers. Participants may get statistical information or even prizes based on how their odds assessments compare to group average assessments or actual outcomes. Reports for participant could rate or assign points based on the participant's ability to predict the group average (or other central tendency), and a participant with a high score could become eligible to win a prize. Such inducements would increase participation and decrease recklessness, and intentionally disruptive participation. Again, a practice of eliminating extreme submissions from central tendency analysis may be needed.

An alternative method could allow odds (probability) assessments from 0% to 100% so that participants in the survey could indicate a belief that an outcome is certain or impossible. The weighting or ranking process described herein or a similar process for assigning weights and a level of belief to responses to the survey questions may be also be used.

Alpha may not require any additional actions by players after the players have submitted IOA's and response weights if response weights are used.

Research embodiment Alpha enables participation by people who are not competing in one of the large group, small group or one-one embodiments. Alpha allows for probability assessments from zero to 100%. It may also use a decimal rating scale ((in addition to and along side the percentage-based probability scale) of zero to 100 points. The decimal rating scale enables the asking of subjective questions with no right and wrong answer or clear outcome.

Alpha may make inquiries in the form of a question as opposed to the form of a command or a statement. The question, “Will President Bush wins re-election?” may be used rather than the statement, “President Bush wins re-election”.

Whenever an Alpha poll (or survey) is conducted, a brief introduction explains that Alpha questions are (preferably) only posed in a manner that enables response using a 0 to 100 rating or probability assessment. For example, an Alpha poll might ask: “How do you rate Tom Hanks as an actor?” “How would you estimate that other survey participants, on average, rate Tom Hanks as an actor?”

Steering and Retrieval of Player Traffic and Attention

The parent and present methods provide for obtaining up-to-date customer profiles as players create and select bets. The methods provide for inducing web surfers (or traffic) to other specific sites to learn more about bet subject matter but with an additional inducement to return to the initial site of the method provider to complete participation in the game. Preferably, bet statements displayed by the system are juxtaposed or otherwise associated with links to commentary and related sources of information about the bet.

Players (or bettors) participating in competitions using the methods described herein are induced to move to other web site URL's by a combination of any of the following inducements: (i) performing research, and gathering and studying related information improves a player's ability to place reasonably accurate odds for bets; (ii) players tend to bet on subjects of interest to them so they are naturally predisposed to find and use convenient links to sources of related information; (iii) players also like to track changes in information or bet status and outcome results, which can be done via links; and/or (iv) the bet statement itself can be based on the status or data or appearance of a site so that players can't learn or appreciate or observe the bet statement content without going to the web site.

Players need to return to the web site of the method provider to use the information they have learned to finalize their bets. The most natural time for them to return to the site is soon they have gathered the information when it is fresh in their minds. Because players are almost always competing in a series of bets they are more likely to repeat the sequence of clicking on a link to investigate a bet and then return to site of the method provider to apply their information and proceed through the game in which they are participating.

The foregoing description has been presented for the purposes of illustration and description. It is not intended to be exhaustive or to limit the invention to the exemplary embodiments disclosed. Many modifications and variations are possible in light of the above teachings. It is intended that the scope of the invention be limited only by the claims appended hereto.

1. A method of determining a bet position comprising:
receiving a first odds assessment from a first player;
receiving a second odds assessment from a second player,
determining a fair odds assessment based on the first odds assessment;
comparing the second odds assessment to the fair odds assessment; and
determining a forced bet position for the second player based on the comparison.

2. A method as defined in claim 1, wherein determining a forced bet position for the second player comprises forcing the second player into one side of a bet if the second odds assessment is greater than the fair odds assessment and forcing the second player into another side of the bet if the second odds assessment is less than the fair odds assessment.

3. A method as defined in claim 1, wherein receiving the first odds assessment comprises receiving a whole number percentage.

4. A method as defined in claim 1, wherein receiving the first odds assessment comprises receiving a whole number percentage via the Internet.

5. A method as defined in claim 1, further comprising:
displaying the first odds assessment after receiving the first odds assessment from a first player; and
hiding the first odds assessment before receiving the second odds assessment from the second player.

6. A method as defined in claim 1, wherein determining a fair odds assessment based on the first odds assessment comprises computing the average of the first odds assessment and the second odds assessment.

7. A method as defined in claim 1, wherein determining a fair odds assessment based on the first odds assessment comprises determining the fair odds assessment to be equal to the first odds assessment.

8. A method as defined in claim 1, further comprising receiving a third odds assessment from a third player, wherein determining a fair odds assessment based on the first odds assessment comprises computing the average of the first odds assessment, the second odds assessment, and the third odds assessment.

9. A method as defined in claim 1, further comprising determining payout amounts for the second player based on the fair odds assessment and the second odds assessment.

10. A method as defined in claim 1, further comprising:
receiving a bet amount from the second player; and
scaling the bet amount based on the fair odds assessment.

11. A method as defined in claim 10, wherein scaling the stake comprises scaling the stake based on the second odds assessment.

12. A method as defined in claim 10, wherein scaling the stake comprises increasing the stake in proportion the difference between the second odds assessment and the fair odds assessment.

13. A method as defined in claim 10, wherein determining a fair odds assessment based on the first odds assessment comprises computing the average of the first odds assessment and the second odds assessment.

14. A method as defined in claim 1, further comprising awarding a bonus to the second player if the second odds assessment is within a predetermined threshold of the fair odds assessment.

15. A method as defined in claim 1, further comprising:
displaying a plurality of bet statements; and
receiving a selection identifying a particular bet statement from the plurality of bet statements.

16. A method as defined in claim 1, further comprising the step of receiving a text based bet statement.

17. A wagering apparatus comprising:
a keyboard;
a display;
a memory storing a software program; and
a processor operatively coupled to the keyboard, display, and memory, the processor being structured to execute the software program, the software program being structured to cause the processor to:
receive a first odds assessment from a first player;
receive a second odds assessment from a second player;
determine a fair odds assessment based on the first odds assessment;
compare the second odds assessment to the fair odds assessment; and
determining a forced bet position for the second player based on the fair odds assessment.

18. A computer readable medium storing a software program structured to cause a computing device to:
receive a first odds assessment from a first player;
receive a second odds assessment from a second player;
determine a fair odds assessment based on the first odds assessment;
compare the second odds assessment to the fair odds assessment; and
determining a forced bet position for the second player based on the fair odds assessment.

19. A method of determining a first bet position and a second bet position comprising:
receiving a first odds assessment from a first player;
receiving a second odds assessment from a second player;
receiving a third odds assessment from a third player;
determining a first fair odds assessment based on the first odds assessment and the third odds assessment;
determining a second fair odds assessment based on the second odds assessment and the third odds assessment;
comparing the first odds assessment to the first fair odds assessment;
determining a forced bet position for the first player based on the comparison of the first odds assessment to the first fair odds assessment;
comparing the second odds assessment to the second fair odds assessment; and
determining a forced bet position for the second player based on the comparison of the second odds assessment to the second fair odds assessment.

20. A method as defined in claim 19 wherein the third player is known to the first player and the second player as a celebrity.
